(19) United States
(12) Patent Application Publication
(10) Pub. No.: US 2026/0157833 A1
(43) Pub. Date: Jun. 11, 2026

(54) METHODS AND TOOTHBRUSH DEVICES FOR AUTOMATED TOOTHBRUSHING

(71) Applicant: Neluva, Inc., Oakland, CA (US)

(72) Inventor: Aaron Silverberg, Oakland, CA (US)

(21) Appl. No.: 19/181,213

(22) Filed: Apr. 16, 2025

Related U.S. Application Data
(60) Provisional application No. 63/634,829, filed on Apr. 16, 2024.

(51) Int. Cl. A61C 17/22; A46B 5/00; A46B 9/04; A46B 13/02; A61C 17/34

(52) U.S. Cl. CPC A61C 17/222; A46B 5/0012; A46B 9/045; A46B 13/023; A61C 17/3418; A61C 17/3427; A61C 17/349

(57) ABSTRACT

A teeth cleaning apparatus is presented. The apparatus can include an arched mouthpiece that conforms to a user's dental arch. The apparatus can include a first brush-head. The first brush-head can include a bristle substrate having two or more planes and being disposed within the arched mouthpiece. The first brush-head can be located on an upper side of the arched mouthpiece. The first brush-head can clean individual teeth of the user while moving from a first position to a second position along the arched mouthpiece. The apparatus can include a transmission track that can have one or two cavities that receive the first brush-head. The transmission track can be located within the arched mouthpiece. The transmission track can facilitate a back-and-forth motion of the first brush-head.

### CROSS-REFERENCE TO RELATED APPLICATIONS

This application claims priority to and the benefit of U.S. Provisional Application No. 63/634,829 titled “Methods and Toothbrush Devices for Automated Toothbrushing” and filed Apr. 16, 2024 which is incorporated herein by reference in its entirety.

### TECHNICAL FIELD

The present disclosure generally relates to the field of toothbrush automation technology and, more particularly to systems and methods for automatically brushing one or more teeth using an automatic teeth cleaning device.

### BACKGROUND

A good practice of maintaining dental health is to brush teeth regularly and thoroughly. Regular brushing reduces the incidence of tooth decay and cavities. Also, brushing and flossing reduce the accumulation of plaque, which is known to cause periodontal disease. If teeth are not brushed regularly and thoroughly, it may cause problems associated with the accumulation of plaque, among other potential risks. Many people, especially children, the handicapped, and the elderly, may not realize that they do not brush properly or sufficiently. Brushing the teeth with a conventional toothbrush is tedious and many users do not brush for sufficiently long periods and/or in a correct manner. Moreover, users of conventional toothbrushes have no reliable way of knowing whether their brushing has been effective in removing plaque and other substances from the teeth.

Various powered toothbrushes have been developed in recent years for facilitating teeth cleaning. However, these powered toothbrushes still have problems. For example, most powered brushes clean one tooth at a time and one side at a time. To brush properly still requires approximately two minutes of brushing and at least some focus. In addition, concentration and efforts for proper technique, such as proper pressure to apply, brushing all the areas, angle of holding brush and more, are still required. Good brushing techniques and skills must still be learned and applied because the technology does not currently provide for that very well.

Additional efforts in recent years also include development of toothbrushes that contain a full set of brushes for every single tooth. While this type of toothbrushes may save time in toothbrushing, they also suffer from over-coverage, among other problems. For example, these toothbrushes allow no space to clean as they tend to brush right up against each other. In addition, some full coverage includes not only all the teeth but the gums as well. Hence a full toothbrush set is problematic. Some space in a brush is needed to allow the brush to stroke back and forth to clean each tooth, even if it is just tiny brush strokes or oscillations. Furthermore, it is difficult to control such full coverage brushes to focus more on needed areas without over brushing other areas.

Therefore, there is a need for improved toothbrush devices that have some inherent intelligence to implement and enforce good brushing techniques with minimal efforts and improved flexibility.

### SUMMARY

A teeth cleaning apparatus is presented. The apparatus can include an arched mouthpiece that conforms to a user's dental arc. In some embodiments, the arched mouthpiece conforms to half of a user's dental arch, or a whole dental arch of the user. In some examples, the mouthpiece does not include a dental arch. The apparatus includes a first brush-head having bristle substrate having two or more planes and being disposed within the arched mouthpiece. The apparatus includes a first brush-head that can be located on an upper side of the arch mouthpiece. The first brush-head cleans individual teeth of the user while moving from a first position to a second position along the arched mouthpiece. The apparatus can include a transmission track having one, two, or more cavities that can be used to receive the first brush-head. In some examples, the transmission track can include a single cavity that receives the first and second brush-heads. The transmission track can be located within the arched mouthpiece. The transmission track can facilitate a back-and-forth motion of the first brush-head.

Various embodiments of the apparatus can include one or more of the following features.

In some embodiments, the apparatus includes a second brush-head that includes a bristle substrate having two or more planes and being disposed within the arched mouthpiece. The second brush-head can clean individual teeth of the user while moving from the first position to the second position along the arched mouthpiece. The second brush-head can clean individual teeth of the user while moving from the second position to the first position along the arched mouthpiece. The transmission track can facilitate a back-and-forth motion of the second brush-head. The apparatus can include the first and second brush-heads connected by a belt. In some examples, the second brush-head can be positioned directly underneath the first brush-head. The arched mouthpiece can include a J-shaped arched mouthpiece. The first brush-head can move in an up-and-down motion. In some examples, the transmission track can include a second cavity that receives the second brush-head. The apparatus can include a power source disposed within a housing of the apparatus. The first position can be located in an inner side of the user's mouth, and the second position can be located in an outer side of the user's mouth.

Another teeth cleaning apparatus is presented. The apparatus includes a brushing cartridge that conforms to a user's dental arch. The apparatus includes a first brush-head having a bristle substrate and being connected by a respective beam to the brushing cartridge. The first brush-head can clean individual teeth of the user while moving from a first position to a second position with respect to the brushing cartridge. The apparatus includes a second brush-head having a bristle substrate and being connected by a respective beam to the brushing cartridge. The second brush-head can be located adjacent to the first brush-head. The second brush-head can clean individual teeth of the user while moving from the second position to the first position with respect to the brushing cartridge. The brushing cartridge can facilitate a back-and-forth motion of the first and second brush-heads.

Various embodiments of the apparatus can include one or more of the following features.

In some embodiments, the first brush-head can be located on an upper side of the brushing cartridge. In some examples, the second brush-head is located on the upper side of the brushing cartridge. The brushing cartridge can include a support structure that receives the first brush-head and the second brush-head. The first position can be located away from the brushing cartridge, and the second position can be located adjacent to the brushing cartridge. The first brush-head and second brush-head can be connected together by a gear. The first and second brush-heads move can move in an up-and-down motion. In some examples, the apparatus can include an arched mouthpiece connected to the brushing cartridge. The arched mouthpiece can have a transmission track that includes two cavities that receive the first brush-head and the second brush-head, respectively. The apparatus can include a power source disposed within a housing of the apparatus.

In the following detailed description of embodiments of the present disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

### BRIEF DESCRIPTION OF THE SEVERAL VIEWS OF THE DRAWINGS

The accompanying figures, which are included as part of the present specification, illustrate the presently preferred embodiments and together with the generally description given above and the detailed description of the preferred embodiments given below serve to explain and teach the principles described herein.

FIG. 1A illustrates an exemplary J-shaped toothbrush, according to some embodiments.

FIGS. 1B-1C illustrate exemplary U-shaped mouthpieces, according to some embodiments.

FIGS. 1D-1E illustrates exemplary flexible U-shaped mouthpieces, according to some embodiments.

FIGS. 1F-1I illustrates exemplary arched mouthpieces, according to some embodiments.

FIGS. 1J-1, and 1J-2 illustrate an exemplary flexible mouthpiece, according to some embodiments.

FIGS. 1K-1, 1K-2, and 1K-3 illustrate an exemplary open-ended mouthpiece, according to some embodiments.

FIG. 1L illustrates an exemplary mechanism for extending a brush-head of a mouthpiece, according to some embodiments.

FIGS. 1M-1, 1M-2, 1M-3 and 1M-4 illustrate exemplary ramp shaped mouthpieces, according to some embodiments.

FIGS. 1N-1, 1N-2, 1N-3, 1N-4, and 1N-5 illustrate exemplary brush-head assemblies having a spring mechanism, according to some embodiments.

FIGS. 1O-1, 1O-2, and 1O-3 illustrate exemplary track features for an additional degree of motion for brush-heads, according to some embodiments.

FIGS. 1P-1Q illustrate exemplary J-shaped mouthpieces having a mirrored portion, according to some embodiments.

FIGS. 1R-1S illustrate exemplary J-shaped mouthpieces having a biteplate, according to some embodiments.

FIG. 2A illustrates an exemplary J-shaped mouthpiece, according to some embodiments.

FIG. 2B illustrates another exemplary J-shaped mouthpiece, according to some embodiments.

FIGS. 2C-1, 2C-2, and 2C-3 illustrate different views of an exemplary brush-head, according to some embodiments.

FIGS. 2D-1, 2D-2, 2D-3, and 2D-4 illustrate exemplary brush-heads, according to some embodiments.

FIG. 2E illustrates exemplary brush-heads, according to some embodiments.

FIGS. 2F-1, 2F-2, 2F-3, and 2F-4 illustrate brush-heads having belt attachments and snap-on brush-heads, according to some embodiments.

FIGS. 2G-1, 2G-2, 2G-3, 2G-4, 2G-5, and 2G-6 illustrate brush-heads having a spring feature, according to some embodiments.

FIG. 2H illustrates a brush-head having a spring like feature, according to some embodiments.

FIG. 2I illustrates an exemplary brush-head having a rounded shape, according to some embodiments.

FIG. 2J illustrates brush-heads having spring like joints, according to some embodiments.

FIG. 2K illustrates brush-heads having a compression structure, according to some embodiments.

FIG. 2L illustrates a brush-head having bristles on a reverse side, according to some embodiments.

FIGS. 3A-1, 3A-2 illustrates different views of an exemplary mouthpiece, according to some embodiments.

FIGS. 3B-1, 3B-2, and 3B-3 illustrate a single track mouthpiece, according to some embodiments.

FIGS. 4A-1, and 4A-2 illustrate an exemplary belt for a mouthpiece, according to some embodiments.

FIG. 4B illustrates an exemplary bearing structure for a mouthpiece, according to some embodiments.

FIG. 4C illustrates an exemplary belt for a mouthpiece, according to some embodiments.

FIGS. 4D-4I illustrate other exemplary belts for a mouthpiece, according to some embodiments.

FIG. 4J illustrates an exemplary driving mechanism for a mouthpiece having a linkage/armature, according to some embodiments.

FIGS. 4K-4M illustrates exemplary linkages and/or arms, according to some embodiments.

FIGS. 5-1, 5-2, and 5-3 illustrate an exemplary handle, according to some embodiments.

FIGS. 6A-1 and 6A-2 illustrate an exemplary mechanism of driving a belt for a mouthpiece, according to some embodiments.

FIG. 6B illustrates a mechanism for converting rotational motion to oscillating motion, according to some embodiments.

FIG. 6C illustrates an exemplary graph illustrating the motion created from an input of a continuous rotational motion, according to some embodiments.

FIG. 6D illustrates an exemplary brush-head oscillating mechanism, according to some embodiments.

FIG. 6E illustrates an exemplary mouthpiece with no track, according to some embodiments.

FIG. 6F illustrates an exemplary brush-head that is directly attached to a handle, according to some embodiments.

FIG. 6G illustrates an offset gear and a shaft used to generate motion of a brush-head, according to some embodiments.

FIG. 6H illustrates a brush-head using a cam or bump feature to provide an axis of motion, according to some embodiments.

FIG. 6I illustrates as shaft moving rotationally, according to some embodiments.

FIG. 6J illustrates an exemplary brush-head showing a drive gear operation, according to some embodiments.

FIG. 6K illustrates an exemplary brush-head that moves in and out of a handle, according to some embodiments.

FIG. 6L illustrates an exemplary brush-head that uses a pivoting arm to generate motion.

FIG. 6M illustrates an exemplary brush-head operable to move along a micro-track within the mouthpiece, according to some embodiments.

FIG. 6N illustrates an example showing brush-head motion converted to rotational motion, according to some embodiments.

FIG. 6O illustrates an example showing brush-head up and down motion generated by a linkage, according to some embodiments.

FIG. 6P illustrates an example showing a chain or belt for a brush-head that is driven around a gear/gasket, according to some embodiments.

FIG. 6Q illustrates an exemplary brush-head having two opposing gears, according to some embodiments.

FIG. 6R illustrates an exemplary brush-head driven by an electromagnet, according to some embodiments.

FIG. 7A illustrates an exemplary removable mouthpiece, according to some embodiments.

FIG. 7B illustrates an exemplary guide for connecting and/or disconnecting mouthpieces, according to some embodiments.

FIG. 7C illustrates an example retention mechanism for attaching a mouthpiece to a handle, according to some embodiments.

FIG. 7D illustrates another exemplary mechanism for attaching a mouthpiece to a handle, according to some embodiment.

FIG. 7E illustrates another exemplary mechanism for attaching a mouthpiece to a handle, according to some embodiments.

FIGS. 7F-1, 7F-2, 7F-3, and 7F-4 illustrate another exemplary mechanism for attaching a mouthpiece to a handle, according to some embodiments.

FIGS. 8A-8D illustrate various exemplary views of a handle, according to some embodiments.

FIGS. 9A-9C illustrate exemplary views of charging base, according to some embodiments.

FIGS. 10-1, 10-2, 10-3, and 10-4 illustrate a teeth cleaning apparatus, according to some embodiments.

FIGS. 10-5, 10-6 and 10-7 illustrate the teeth cleaning apparatus from FIG. 10-1 to 10-4 during operation, according to some embodiments.

FIGS. 10-8, 10-9, and 10-10 illustrate a plurality exemplary brushing cartridges, according to some embodiments.

FIGS. 10-11 and 10-12 illustrate an opened up brushing cartridges 1004, 1020, according to some embodiments.

FIG. 10-13 illustrates an exemplary handle, according to some embodiments.

FIG. 10-14 illustrates a bayonet feature, according to some embodiments.

FIG. 10-15 illustrates a handle engaged with a cartridge, according to some embodiments.

FIG. 10-16 illustrates a brushing cartridge having a movable central brush, according to some embodiments.

FIGS. 10-17, 10-18 and 10-19 illustrate a cartridge having a central guide, according to some embodiments.

FIGS. 11-1, 11-2 and 11-3 illustrate a brushing cartridge for a teeth cleaning apparatus, according to some embodiments.

FIGS. 12-1, 12-2, 12-3 and 12-4 illustrate an exemplary configuration using linear motion for driving an armature to add in another degree of motion for a brush-head, according to some embodiments.

FIGS. 13-1, 13-2, 13-3 and 13-4 illustrate a slot pin configuration for a brush-head, according to some embodiments.

FIGS. 14-1, 14-2 and 14-3 illustrate a brush-head having a pivot, according to some embodiments.

FIG. 15 illustrates a block diagram showing control system hardware components of a powered toothbrush, according to some embodiments.

FIG. 16 illustrates an example user interface for a software application (App) running on a mobile device, according to some embodiments.

While the present disclosure is subject to various modifications and alternative forms, specific embodiments thereof have been shown by way of example in the drawings and will herein be described in detail. The present disclosure should be understood to not be limited to the particular forms disclosed, but on the contrary, the intention is to cover all modifications, equivalents, and alternatives falling within the spirit and scope of the present disclosure.

### DETAILED DESCRIPTION

In the following detailed description of embodiments of the present disclosure, numerous specific details are set forth in order to provide a more thorough understanding of the disclosure. However, it will be apparent to one of ordinary skill in the art that the disclosure can be practiced without these specific details. In other instances, well-known features have not been described in detail to avoid unnecessarily complicating the description.

As used throughout this specification, the words “up,” “down,” “back,” “forth,” “longitudinal,” “proximal,” “distal,” and other similar directional words are used with respect to the views being described. It should be understood that the automated toothbrushes described herein can be used in various orientations and is not limited to use in the orientations illustrated in the drawing figures.

Methods and systems for automatically brushing one or more teeth are presented herein. In some examples, the method can include automated brushing of more than one tooth of a user using a powered toothbrush with an arched part. The systems can include toothbrush devices for automated brushing of one or more teeth of the user.

According to some embodiments, the disclosure provides an optimal method of smartly simultaneous brushing of more than one tooth and/or more than one side of a tooth, which saves time in ordinary teeth brushing and minimizes the efforts in teeth brushing without sacrifice of performance of teeth cleaning. The disclosed method also ensures that the bristles are hitting the teeth/gums at the optimal angle with the right pressure. In addition, the automated motion disclosed herein can effectively replicate a proven method of brushing. Therefore, the disclosed method encourages users to correctly brush and in less time than they would ordinarily require in order to effectively control plaque buildup.

According to some embodiments, the disclosure provides a powered half mouth toothbrush device for simultaneously brushing the facial, lingual, occlusal and incisal surfaces of the maxillary and mandibular teeth. In some embodiments, the disclosed toothbrush can be a J-shaped toothbrush, which is a half mouth form factor that would brush one half (e.g., left side or right side) of the mouth at a time. The disclosed toothbrush can be a half mouth toothbrush that can be inserted through the mouth opening yet fit the mouth cavity for simultaneous brushing of teeth with one form factor. The J-shaped toothbrush can have a smaller size than a full coverage toothbrush, which allows for smaller footprint, more comfort, and accommodates a wider range of mouth sizes without having to actively adjust/resize, thereby improving the flexibility and comfortability. It should be noted that “J-shape” is just used to roughly describe the shape of the toothbrush, but not for limitations. In actual applications, many different J-shaped toothbrushes can be produced and used, where these different J-shaped toothbrushes can vary in exact shapes and sizes, while their general patterns follow a “J-shape” as shown in the drawings in the present disclosure.

According to some embodiments, the disclosure also provides a powered full mouth toothbrush device for simultaneously brushing the facial, lingual, occlusal and incisal surfaces of the maxillary and mandibular teeth. In one embodiment, the disclosed toothbrush can be a full mouth toothbrush that can actually be inserted through a mouth opening of a user yet fit a mouth cavity of the user for simultaneous brushing of the user's teeth. For example, the disclosed toothbrush can include a U-shaped toothbrush that fits a distribution of mouth sizes with one form factor, such as a U-shaped toothbrush whose U-fork span dimension can be flexible enough to enter a smaller mouth cavity dimension and expand in a larger volume, e.g., inside the mouth cavity, to provide the brushing coverage to all teeth of the user regardless of mouth size. In some embodiments, the U-shape toothbrush can be flexible and/or adjustable to the unique teeth arch of the users.

According to some embodiments, the disclosure further provides intelligence to a powered toothbrush device that can have more than all-or-nothing operational modes, such as operational modes that can account for individual teeth care. For example, described here is a smart toothbrush. The smart toothbrush can be programmed to brush more than one tooth of the user therapeutically and/or individually, accounting for time and position of brushing each tooth of the user. In addition, by including proper sensing mechanisms, the smart toothbrush can also be programmed to automate hygienic tooth care, whereby the toothbrush eliminates user error such as missing regions of the mouth/teeth, pressing too hard or too light on teeth, not brushing long enough, and/or not holding the brush the right angle.

It is to be noted that the benefits and advantages described herein are not all-inclusive, and many additional features and advantages will be further described under the context of specific embodiments. In addition, some additional features and advantages will become apparent to one of ordinary skill in the art in view of the figures and the following descriptions.

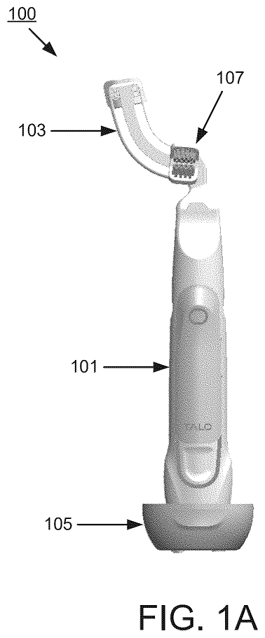

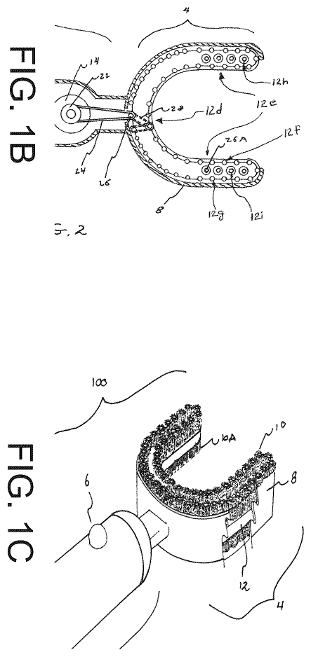

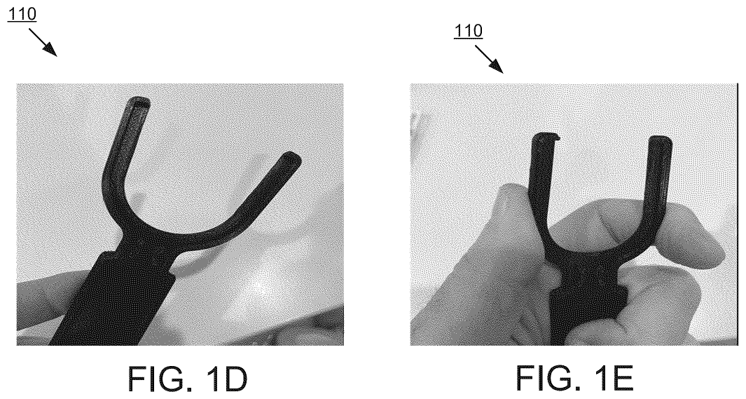

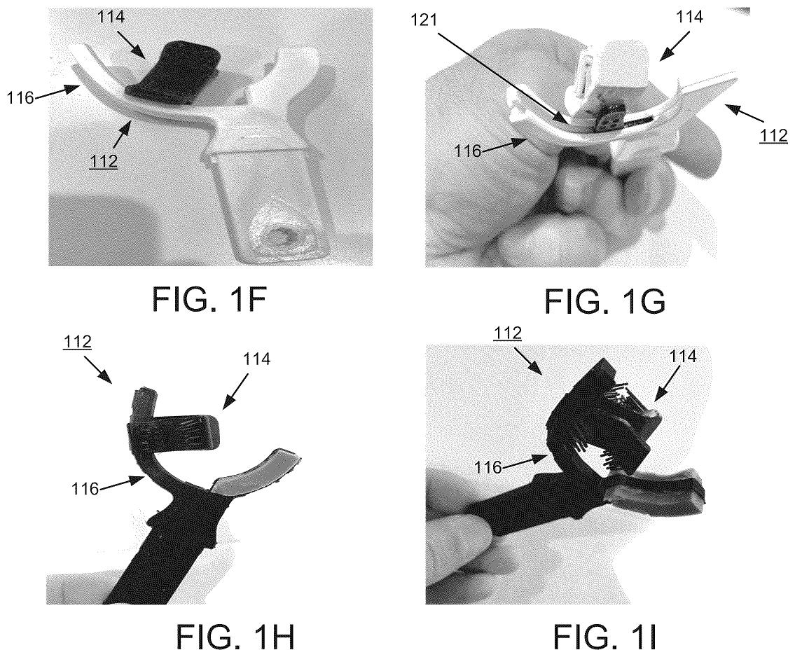

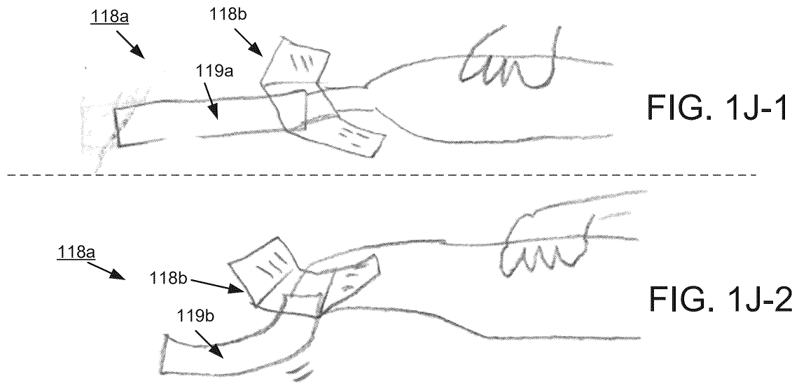

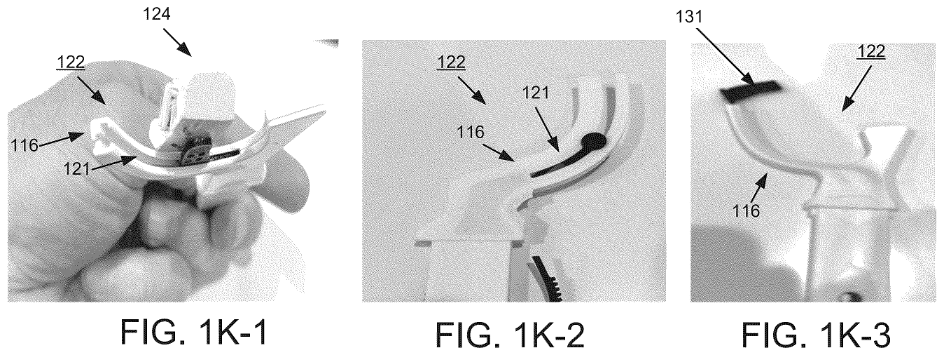

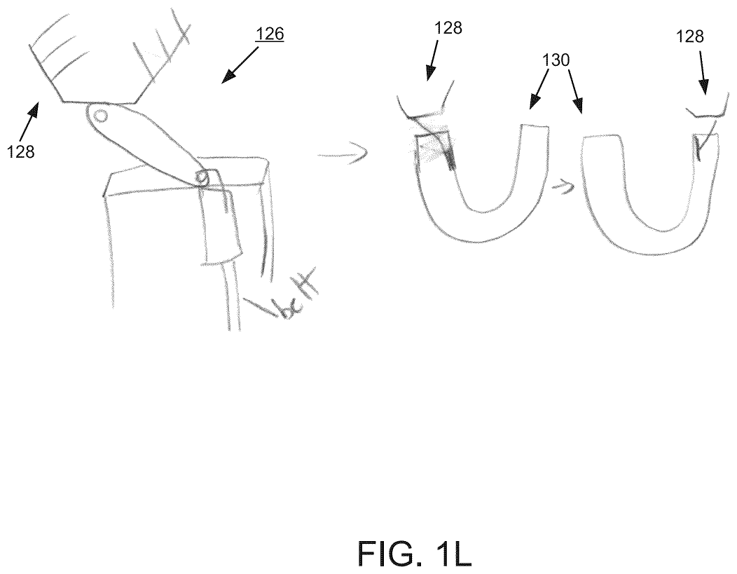

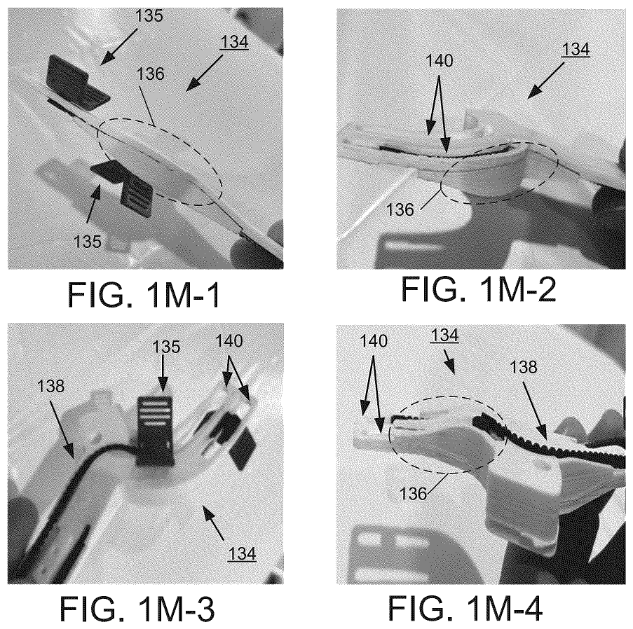

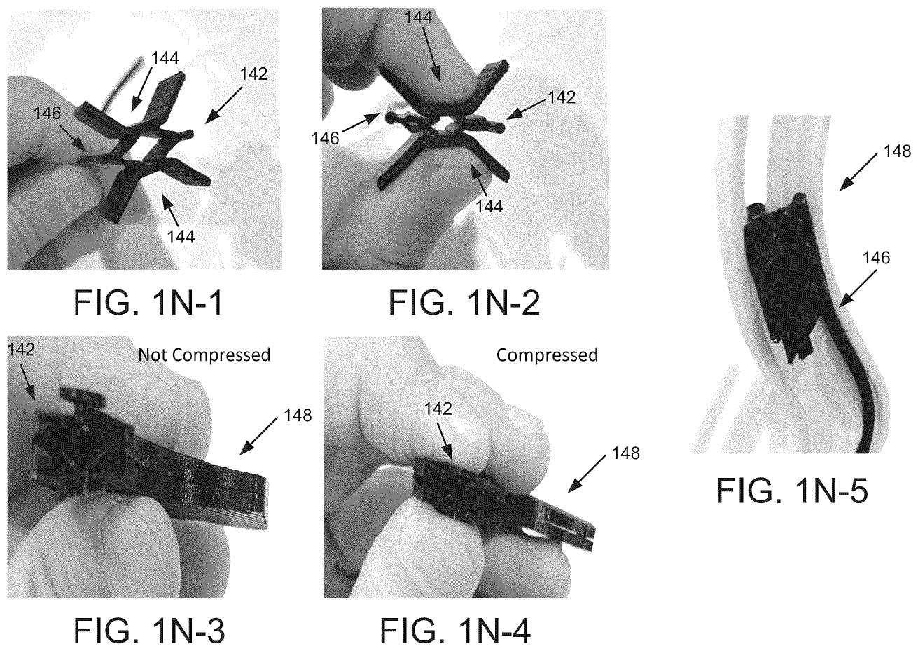

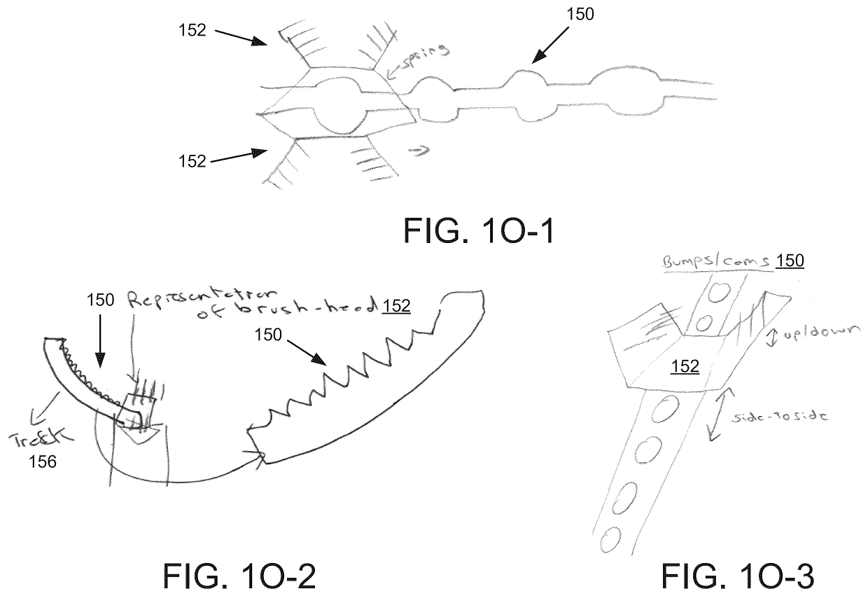

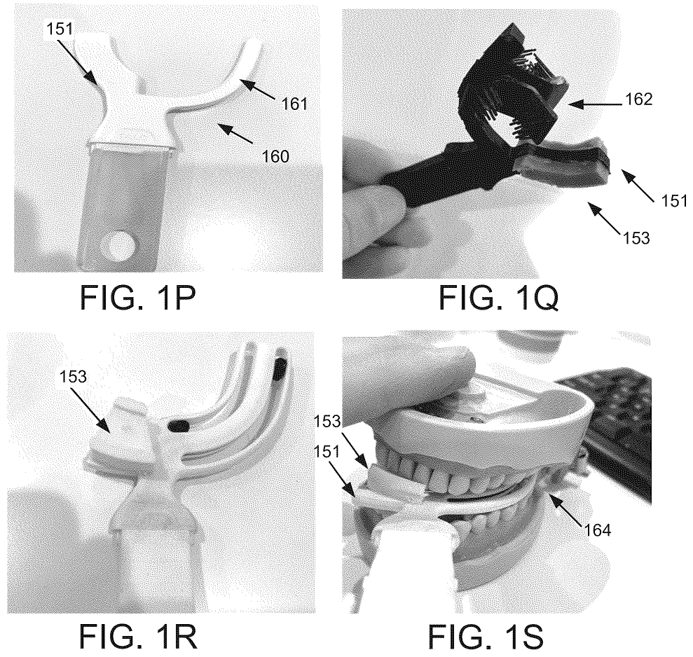

FIG. 1A illustrates an exemplary overall structure of a J-shaped toothbrush 100, according to some embodiments. As described herein, the J-shaped toothbrush can also be referred to as a teeth cleaning apparatus, teeth cleaning device, a toothbrush, among other terms. In some embodiments, the toothbrush 100 includes a handle 101, a J-shaped mouthpiece 103 (also referred to as “cartridge”) attached to the handle 101, and a charging base 105 for charging the powered toothbrush 100. The charging station 105 can include a wired and/or wireless charging station. As also illustrated in FIG. 1A, the toothbrush 100 further includes a detachable brush-head 107 that can be activated to move (e.g., rotate, move up/down, move left/right, or move in other directions) to brush a tooth of a user. Once one tooth of the user is brushed (e.g., after a certain period or certain movement patterns), the brush-head 107 can be further controlled to move along the mouthpiece 103 without necessarily requiring the user to move the toothbrush handle 101 or mouthpiece 103, thereby achieving an automated teeth brushing for half of a mouth of the user. In some examples, to brush the other half of the mouth, the user can flip the mouthpiece 103 over, e.g., without additional effort, since a user's mouth is generally symmetric from left to right. In some embodiments, the mouthpiece 103 can include one or more tracks as shown. The tracks can receive the brush-head 107. In some examples, each track can include a corresponding cavity. The cavity can be used to receive the brush-head 107. The brush-head 107 can move along the track of the mouthpiece 103 to clean one or more teeth of the user. In some embodiments, the brush-head 107 can move from a first position, e.g., at bottom portion of the mouthpiece 103 closer to the handle 101 in FIG. 1A, to a second position, e.g., a top portion of the mouthpiece 103 away from the handle 101. In some examples, the first position and the second position can be reversed. For example, the first position can be at the top portion of the mouthpiece 103, away from the handle 101, and the second position can be at a bottom portion of the mouthpiece 103, closer to the handle 101 in FIG. 1A. The first and second positions described are exemplary, and other positions along the track of the mouthpiece 103 can be used. As described herein, the track can also be referred to as a transmission track. In some non-limiting examples, the brush-head 107 can sit within the cavity of the track, the brush-head 107 can be molded as one piece to the track, the brush-head 107 can be sonic welded to the track, the brush-head 107 can be glued to the track, among other ways of connecting the brush-head 107 to the track of the mouthpiece 103.

It should be noted that while only one brush-head 107 is visible in FIG. 1A, in actual applications, there can be more than one brush-head 107 attached along the mouthpiece 103. For example, there can be two brush-heads 107, each attached to one side of the mouthpiece 103, and which can be responsible for cleaning a top or bottom part of the user's half-mouth, respectively.

In some embodiments, there can be two J-shaped mouthpieces 103 attached to the same handle 101, so that the two mouthpieces together form a U-shaped mouthpiece. In this way, the user can use a U-shaped mouthpiece or can use a J-shaped mouthpiece for brushing the teeth, depending on the user's preference. For example, the user can feel uncomfortable when beginning to use the disclosed toothbrush, and thus choose a J-shaped toothbrush at the first few weeks or months. After the user feels more comfortable, the user can choose a U-shaped mouthpiece by simply adding another J-shaped mouthpiece to the current one. In some examples, such a toothbrush can include a mode switch function to allow the user to choose J-shaped mode or U-shaped mode, based on whether one or two pieces of J-shaped mouthpiece are attached to the handle 101.

In some embodiments, there can be one single form U-shaped mouthpiece attached to the handle 101 instead, where each side the U-shaped mouthpiece has one or more than one brush-head to attached to the mouthpiece, to save time in teeth brushing.

In some alternative embodiments, a user can actually move a brush-head over his/her teeth, gliding it from tooth to tooth. That is, after one tooth is automatically brushed, the user can push the brush-head to the next tooth, or any another tooth, or keep it at the current position. This can allow the user to brush some teeth with a longer time, while other teeth with less time or even not brushed if the user is in a hurry.

FIGS. 1B-1C illustrate conventional U-shaped mouthpieces, according to some embodiments. In both FIGS. 1B and 1C, show a toothbrush/mouthpiece that has brushes for every tooth/every side of the tooth of a user. In some applications, conventional mouthpieces similar to FIG. 1B, 1C can include a U-shaped toothbrush/mouthpiece that can depend on a rigidity of the mouthpieces. In some examples, the toothbrushes/mouthpieces of FIGS. 1B and 1C brushes and/or components that cover every tooth of the user, which is in contrast to the systems and methods presented herein.

FIGS. 1D-1E illustrate exemplary arched mouthpieces, according to some embodiments. While these mouthpieces are similarly U-shaped, compared to those shown in FIGS. 1B-1C, these mouthpieces can be “springy” and/or flexible to fit in/out of the user's mouth and allow the user to place brush-head (e.g., brush-head 107) over the user's teeth. The flexibility of the mouthpiece can allow it to better fit around a natural arc of different users' jaw shape. Due to the nature of the mouthpiece, the mouthpiece can accommodate this feature, whereas a fixed/rigid set of bristles/brush-heads shown in FIGS. 1B-1C that cover the entire mouth can find it challenging to accommodate.

FIGS. 1F-1I illustrate illustrates exemplary arched mouthpieces 112, according to some embodiments. In some embodiments, the exemplary arched mouthpieces 112 can include mouthpieces that have an arched part, similar to that described regarding the J-shaped mouthpieces shown in FIG. 1A, 1D, 1E above. In this type of mouthpiece, brush-heads 114 use the track 116 as a rail and guide along it during the movement from one tooth to another, as indicated by arrow 121. In such a design, the brush-heads 114 can be aligned back-to-back, which can be slidably attached to the rail 116, as shown in FIG. 1I. It should be noted that, while the brush-heads 114 are shown as aligning on an inner side of a mouthpiece 112, in some embodiments, the brush-heads 114 can align on outer side of a mouthpiece 112. In such case, the actual size of mouthpiece 112 can smaller when compared to the mouthpieces where the brush-heads are aligned on an inner side.

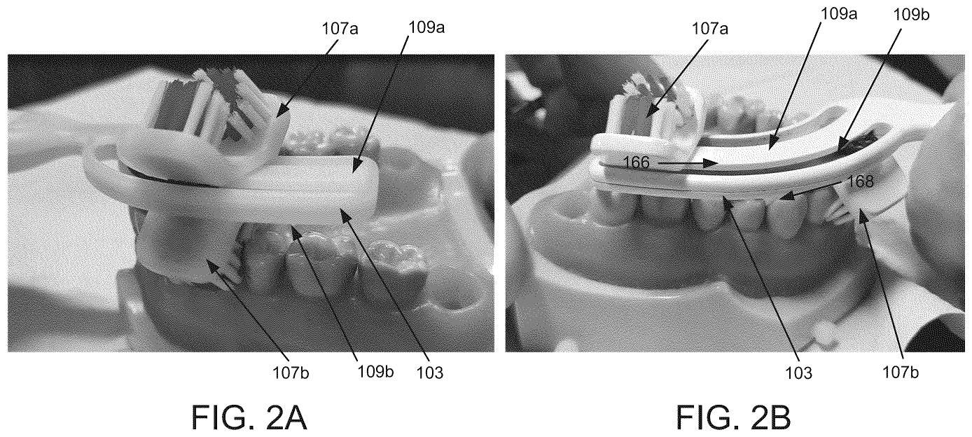

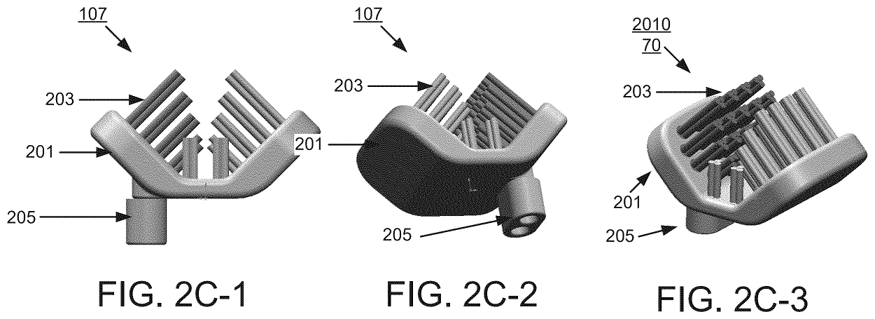

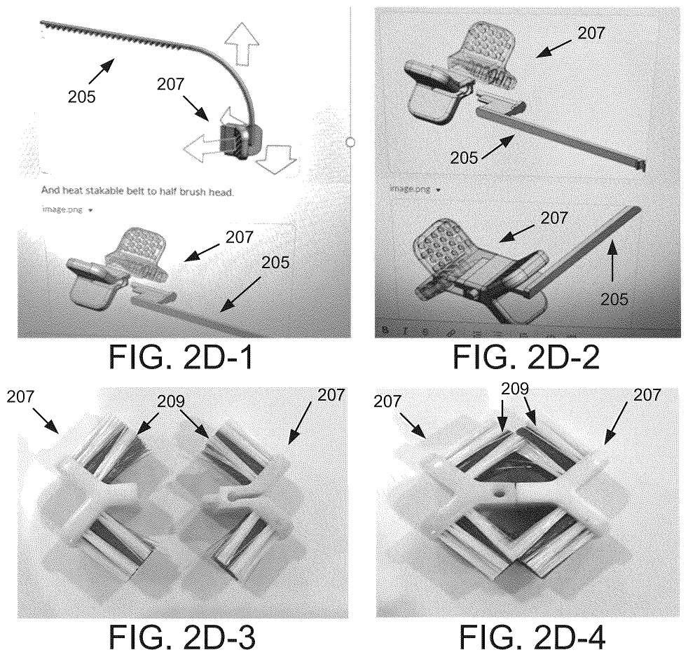

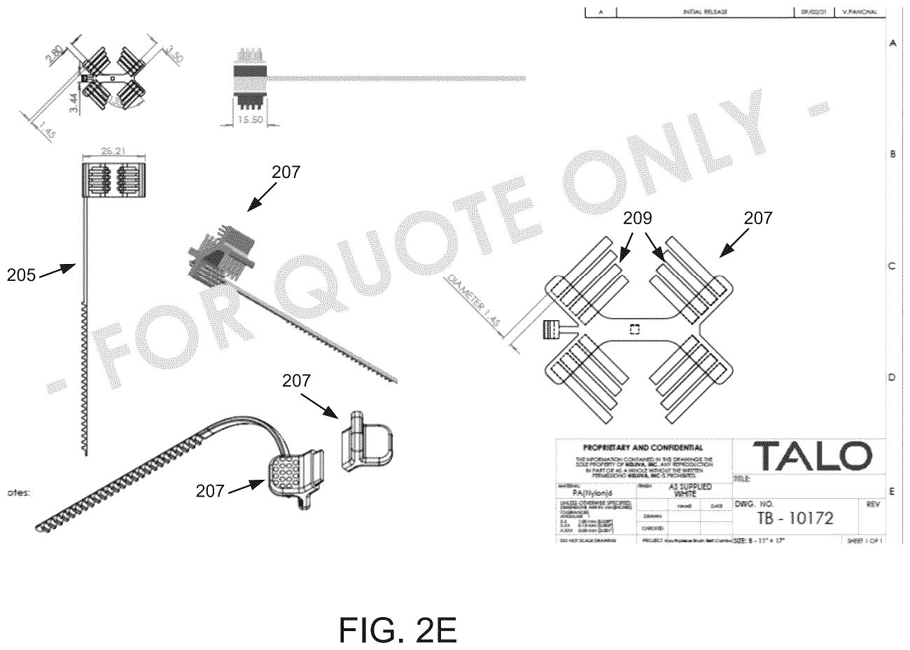

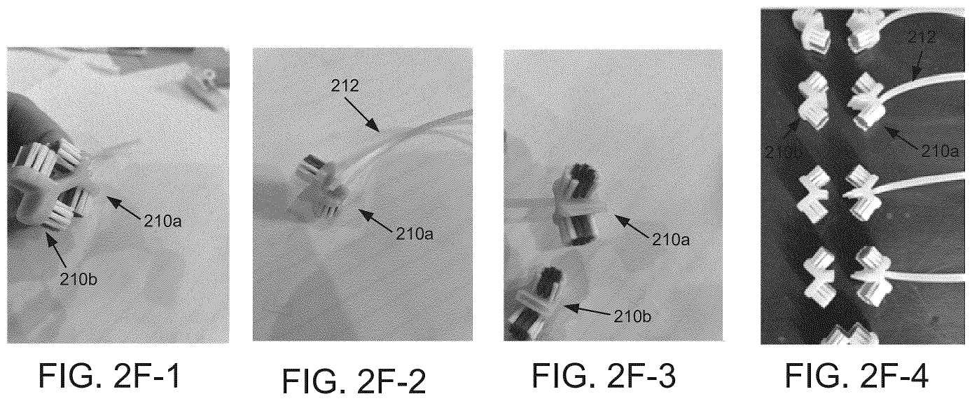

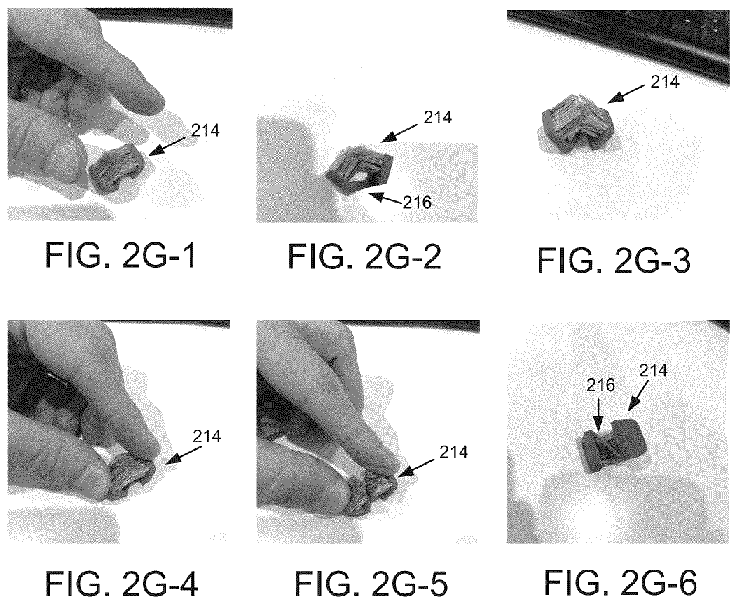

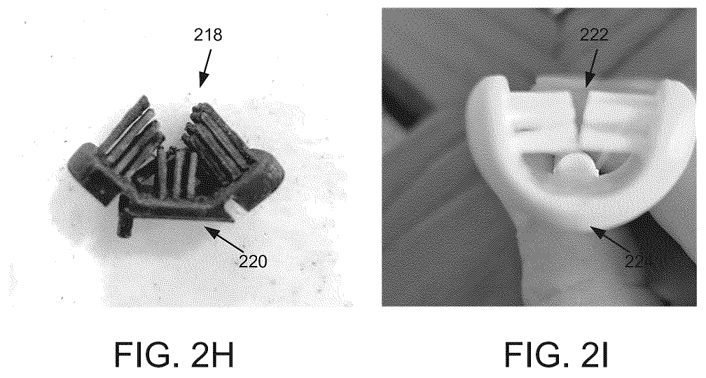

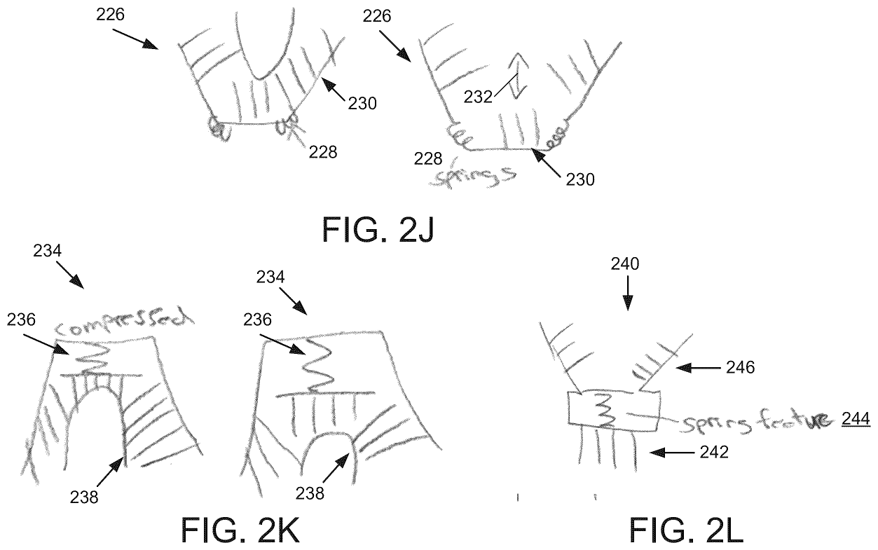

FIGS. 1J-1, and 1J-2 illustrate another exemplary mouthpiece 118a, according to some embodiments. FIGS. 1J-1 and 1J-2 can collectively be referred to herein as FIG. 1J. In some embodiments, the mouthpiece 118a can include a flexible mouthpiece. The mouthpiece 118a can have an adjustable shape. In one example, the mouthpiece 118a includes a rail 119a, 119b that is flexible. In one example, the mouthpiece 118a includes a rail that can be formed into a straight shape 119a as shown. The rail can be formed into a slightly curved shape 119b, such that the user can more easily insert the mouthpiece 118a into his/her mouth and the mouthpiece 118a bends around the natural curvature of his/her teeth. In some examples, the rail's shape can be adjusted include straightening, bending, curving, and/or adjusting the shape of the rail. As can be seen from FIG. 1J, the rail of the mouthpiece 118a can be flexible and/or easy to bend 119b, so that when brush-heads 118b move along the rail 119a, 119b of the mouthpiece 118a, the rail 119a, 119b of the mouthpiece 118a can easily be shaped into a curve shape 119b according to the curvature of the user's teeth. Additionally or alternatively, the mouthpiece 118a can include a hinge that allows it to bend/unbend to form a desired curvature.

FIGS. 1K-1, 1K-2, and 1K-3 illustrate an exemplary open-ended mouthpiece 122, according to some embodiments. FIGS. 1K-1, 1K-2, and 1J-3 can collectively be referred to herein as FIG. 1K. In some embodiments, FIG. 1K shows various examples of the mouthpiece 122 that allows a brush-head 124 to travel beyond the length of the track 116 of the mouthpiece 122. This can allow the brush-heads 124 and/or cartridges to have smaller profiles, which can offer greater flexibility of length for mouths of different sizes. Arrow 131 indicates a brush-head that extends beyond the track 116.

FIG. 1L illustrates an exemplary mechanism for extending a brush-head of a mouthpiece, according to some embodiments. In some examples, FIG. 1L shows an example mechanism 126 for extending brush-head reach. Similar to the open-end cartridge concept shown in FIG. 1K, FIG. 1L shows a mechanism 126 for letting a brush-head 128 travel beyond a length of a fixed track 130. This can also allow for using a closed track (non-open ended). The mechanism 126 uses a pivot or locking pivot to keep the brush-head 128 stable when moving through the cartridge. However, when the brush-head 128 gets to the end 130 of the track, the brush-head 128 can extend as needed (e.g., through rotation and/or an extension bar), as shown in FIG. 1L.

FIGS. 1M-1, 1M-2, 1M-3 and 1M-4 illustrate exemplary ramp shaped mouthpieces 134, according to some embodiments. FIGS. 1M-1, 1M-2, 1M-3 and 1M-4 can collectively be referred to herein as FIG. 1M. In some embodiments, FIG. 1M shows various examples of a mouthpiece 134 having a ramp shape. That is, the mouthpiece 134 can have a ramp profile 136 such that the mouthpiece 134 can be thicker in front and get narrower towards a back the of the user's mouth, which can make the mouthpiece 134 more closely follow a natural angle of an opened mouth of the user. This configuration can allow the mouthpiece 134 to better reach all user's teeth, be more comfortable, provide more comfortable fit and also provide more stability, especially with moving brush-heads 135 since the mouthpiece 134 more closely fits the natural curve of the user's open jaws. As can be seen in the lower two images in FIG. 1L, one method of using a ramp profile 136 can be use a belt-driven system 138 that has two tracks 140 that the belt travels in diverge such as to follow the ramp profile 136.

It should be noted that a ramp-shaped mouthpiece can be useful for other developments aimed to developing automatic forms of toothbrushing/oral health/flossing, or other mouth cleaning tools or equipment.

FIGS. 1N-1, 1N2-, 1N-3, 1N-4, and 1N-5 illustrate exemplary brush-head assemblies having a spring mechanism, according to some embodiments. FIGS. 1N-1, 1N-2, 1N-3, 1N-4, and 1N-5 can collectively be referred to herein as FIG. 1N. In some embodiments, FIG. 1N shows another method of having a ramped profile using a spring 142 between brush-head 144 and a belt 146. The spring 142 can include a compression or expansion spring between the belt 146 and the brush-head 144 such that the brush-head 144 can expand and compress to follow the profile of the ramp shape. In the example images shown in FIG. 1N, two brush-heads 144 are connected together as part of one assembly that has a middle section that acts as a compression spring 142 and connects to the belt 146, as shown in the right image. In the same image, the spring 142 is a V-shaped (open-ended) spring, which can be compressed from the open end. In this type of ramp profile, the brush-heads 144 on the top and bottom can move in the same direction, as shown in the top two images of the left part. In some embodiments, the ramp profile can be configured for one brush-head 144. If only one set of teeth is being brushed (i.e., only having a brush-head 144 on the top or only having a brush-head 144 on the bottom), a ramp cartridge could can be used where the brush-head 144 can be driven along a ramp-shaped track 148.

In some embodiments, the ramp cartridge allows the brush-head 144 to contour side-to-side and pivot to better fit/reach people's teeth, which do not perfectly come out straight. In some embodiments, a flat cartridge (non-ramp) can also utilize a springy brush-head to have this feature and allow pivot.

In some embodiments, the track can contain bumps/bridges (i.e., cam/shaft type setup, etc.) or other shape features that cause the brush-head 144 to add an additional axis of motion as it is being driven along the track, causing the brush-head (such as in the top two images in the left part of FIG. 1M) to pivot or rock back and forth to different degrees in addition to the primary motion, allowing it to better reach/clean teeth and/or gums. That is, this configuration allows the brush to go up and down or side-to-side in addition to advancing down the track.

FIGS. 1O-1, 1O-2, and 1O-3 illustrate exemplary track features for adding an additional degree of motion for brush-heads, according to some embodiments. FIGS. 1O-1, 1O-2, and 1O-3 can collectively be referred to herein as FIG. 1O. In some embodiments, FIG. 1O shows some example vertical translation methods for moving brush-heads 152. In the disclosed vertical methods, along the lines of the pivot action, slide above where it can cause the brush of a brush-head 152 to rock back and forth. Another embodiment is adding in up/down movements to the brushes of the brush-heads 152. The cartridge (mouthpiece) can include track features 150 that passively oscillate the brush-heads 152 up and down vertically with or without oscillating back and forth. This can be done with various means, including adding a bump or cam 150 like feature in the track 156 or into the brush-heads 152, such that when the brush of the brush-heads 152 are driven along the track 156, the bumps or cams 150 will cause the brush-head 152 to raise up/down as it brushes the user's teeth. The configuration shown in FIG. 1O can be added through additional motion created in a handle of a mouthpiece translated to a belt system of the mouthpiece.

FIGS. 1P-1Q illustrate exemplary J-shaped mouthpieces having a mirrored portion, according to some embodiments. FIGS. 1P-1Q shown an example mirror side for a J-shaped mouthpiece. As illustrated in the images, a J-shaped mouthpiece 160 can have a track side 161 which includes a track for a brush-head to move along. As also illustrated in these two images, the J-shaped mouthpiece 160 can have a mirrored side 151, which is an area mirrored on the other half of the mouth to help balance/create more stability in the mouthpiece 160 by limiting the free-motion possible. This can be as simple as just a shaped feature, without a soft “bite plate” 153 type material. The mirror side 151 can not include a track for a brush-head to move along, according to some embodiments. In addition, as can be seen from FIGS. 1O-1Q, the mirrored side 151 can have a size smaller than the main track.

FIGS. 1R-1S illustrate exemplary J-shaped mouthpieces having a biteplate, according to some embodiments. FIGS. 1R-1S shown an example biting plate 153 for a J-shaped mouthpiece 160. A biting plate 153 can include an area a user can rest the user's teeth on or bite on (can be expanding or compressible material). The biting plate 153 can help create stability and keep cartridge stationary while there is motion in the mouth via the brush-heads 162. In addition, the biting plate 153 can help balance the alternate side of mouth 164 that is not being brushed (in case of half mouth cartridge). In some embodiments, the biting plate 153 can have features like ridges and the like to make brushing the user's teeth be more stable.

In some embodiments, a mouthpiece can have additional features not described above.

FIG. 2A illustrates an exemplary J-shaped mouthpiece 103, according to some embodiments. As illustrated in FIG. 2A, the mouthpiece 103 includes two separate brush-heads 107a and 107b attached thereto. In some examples, the two brush-heads 107a, 107b, are located at about the same locations (e.g., align to the cartridge 103 back-to-back). During actual brushing, the two brush-heads 107a and 107b can be controlled to move along a same direction when switching from one tooth to a next tooth. In some examples, the brush-head 107a located on an upper side 109a of a track the mouthpiece 103, and the brush-head 107b located on a lower side 109b of the rack of the mouthpiece 103.

FIG. 2B illustrates another exemplary J-shaped mouthpiece 103, according to some embodiments. As illustrated in FIG. 2B, the mouthpiece 103 can include two separate brush-heads 107a and 107b attached thereto. The two brush-heads can be located at different locations (e.g., one located at proximal end (an end close to the handle) and the other located at distal end of the J-shaped mouthpiece). During actual brushing, the two brush-heads 107a and 107b can be controlled to move along opposite directions 166, 168. That is, one brush-head 170a can be controlled to move 166 from inner toward front of a mouth, while the other brush-head 107b can be controlled to move 168 from front to inner part of the mouth. By controlling the two brush-heads 107a, 107b to move in opposite directions 166, 168, the mouthpiece 103 can create an opposite forces while brushing, thereby creating a more balanced and comfortable brushing experience.

FIGS. 2C-1, 2C-2, and 2C-3 illustrate different views of an exemplary brush-head 107, according to some embodiments. FIGS. 2C-1, 2C-2, and 2C-3 can collectively be referred to herein as FIG. 2C. As illustrated, a brush-head 107 can include a base 201, a set of bristles 203, and a belt connection 205. In some examples, the belt connection 205 can be optional. The base 201 have three plane surfaces supporting three sub-sets of bristles 203, each subset responsible for brushing a tooth from one side through motions of the subset of bristles. Each plane can be embedded with a movable component that is independently controlled to move following a certain pattern (e.g., rotation along an axis, or move up/down and/or left/right following a specific pattern) to ensure each side of a tooth to be sufficiently brushed. Each subset of bristles 203 can be made of same or different materials, and can have the same or different mechanical properties. Even for a same subset of bristles, different parts can have different mechanical properties. For example, the parts for brushing gums can have less strength when compared to parts for brushing merely teeth surfaces. In addition, the lengths and/or density of bristles for each subset can also vary, and can have different configurations, so that different options can be offered to allow different persons to select from based on his/her preference and/or teeth conditions. It should be noted that, while there are three sub-sets of bristles shown in FIG. 2C, in some embodiments, the brush-head 107 could just have bristles on the two opposite sides but not the bottom side. The opposite bristles can be arranged/angled in such a way that they still perform the function of brushing/reaching all sides of a tooth.

The belt connection 205 can be configured to connect (e.g., can connect) to a belt that drives a brush-head to move along one specific direction. The connection can be established through different means. In some embodiments, a snap-in connection that allows an easy replacement of a brush-head can be used.

FIGS. 2D-1, 2D-2, 2D-3, and 2D-4 illustrate exemplary brush-heads 207, according to some embodiments. FIGS. 2D-1, 2D-2, 2D-3, and 2D-4 can collectively be referred to herein as FIG. 2D. In the example brush-head 207 shown in the top two images FIGS. 2D-1, 2D-2, the belt 205 is one part with a heat staking connection to the brush-head 207 (which has two parts), which all connect to form a single brush-head/belt part. One of the benefits of this type of brush-head 207 is that the brush-head 207 can be moldable, easy to assembly, and can be capable of tufting with bristles, which cannot be done with conventional brush-heads. In the example brush-head 207 shown in the bottom two images FIGS. 2D-3, 2D-4, the brush-heads 207 without a belt 205 are illustrated. In all of the brush-heads shown in FIG. 2D, the bristles 209 are not necessarily cut to length. In some embodiments, bristles 209 can also be added on the bottom or at different angles if desired.

FIG. 2E illustrates exemplary brush-heads, according to some embodiments. In some embodiments, FIG. 2E shows exemplary views of the brush-heads 207 shown in FIG. 2D. In some examples, FIG. 2E shows the brush-heads 207, belt 205 and bristles 209 from FIG. 2D.

FIGS. 2F-1, 2F-2, 2F-3, and 2F-4 illustrate brush-heads having belt attachments and snap-on brush-heads, according to some embodiments. FIGS. 2F-1, 2F-2, 2F-3, and 2F-4 can collectively be referred to herein as FIG. 2F. In some embodiments, the brush-heads 210 can include a brush-head 210a that is formed with belt 212 attached while the second half of the brush-head 210b is snapped together (not removable) and permanently connected through sonic welding, heat, etc., to the other brush-head 210a. FIG. 2F further illustrates some images for the example brush-heads shown in FIG. 2E. In these images, the brush-heads are made of two pieces, one of the brush-heads 210a is molded with the belted attached, while the other brush-head 210b is snapped together with the one with the attached belt 212.

FIGS. 2G-1, 2G-2, 2G-3, 2G-4, 2G-5, and 2G-6 illustrates brush-heads having a spring like feature, according to some embodiments. FIGS. 2G-1, 2G-2, 2G-3, 2G-4, 2G-5, and 2G-6 can collectively be referred to herein as FIG. 2G. FIG. 2G shows brush-heads 214 have the spring-like feature 216 molded into the brush-heads 214 or as a part of the brush-heads 214. The spring 216 can take different forms, but generally, giving a little pressure to the spring 216 can allow the brush-head 214 to spread open to accommodate different teeth when the brush-head 214 is being used to brush the teeth of the user. For example, the spring 216 can allow for adjustment from the incisors (front teeth) to molars (inner teeth) that have a different shape and/or size.

FIG. 2H illustrates a brush-head having a spring like feature, according to some embodiments. In some embodiments, a brush-head 218 is shown that includes a spring like feature 220. In some examples, the spring like feature 220 can not be an actual spring. The spring like feature 220 can be created into the brush-head 218, e.g., the spring like feature 220 can allow the brush-head 218 to have a little bit of flexibility to get stretched to open as needed.

FIG. 2I illustrates an exemplary brush-head having a rounded shape, according to some embodiments. In some embodiments, the brush-head 222 represents a rounded brush-head known in the art and used in conventional tooth brushing applications. The brush-head 222 can include a rounded shape 224. In some examples, an overall shape of the brush-head 222 can include a half circle. As shown, the brush-head 222 can have a rounded portion 224 at a bottom part of the brush-head 222. To make such a rounded brush-head, in one embodiment, a base plane of the brush-head 222 can be first molded flat. While flat, bristles can be inserted into the brush-head 222, and then the brush-head 222 can be bent to create the rounded shape 224 shown in FIG. 2I. Although the rounded shape 224 is shown for the brush-head 222, other types of shapes can be formed.

FIG. 2J illustrates a brush-head having a rounded shape, according to some embodiments. In some embodiments, the brush-head 226 includes joint 228. The join 228 can be molded from a plastic material, or molded into a shape allows the brush-head 226 to flex and open up when pressure is applied to the brush-head 226. In some examples, the joint 228 can include a spring. The joint 228 can be flexible, e.g., can extend and/or compress. In one example, the joint 228 can act as a spring and/or include a flexible configuration that provides for a spring-type function. When compared to the brush-head 222 shown in FIG. 2H, the primary difference is that the brush-head 226 can allow for a bottom side with bristles 230 to stretch down and accommodate larger teeth.

FIG. 2K illustrates brush-heads having a compression structure, according to some embodiments. In some embodiments, brush-heads 234 having a bottom area including a compression structure 236 that can be molded as a feature into the assembly is shown. In some examples, the compression structure 236 can include a spring. In one example, the compression structure 236 can include features which allow the brush-head 234 to extend and/or compress much like a spring. As the brush-head 234 goes over the user's tooth, the compression structure 236 can allow the brush-head 234 to better accommodate the differences between smaller/larger teeth of different users. Another advantage is that if an up/down motion is added to the brushing mechanism (vertical translation) of a mouthpiece, bristles 238 of the brush-head 235 for a biting surface of the mouthpiece can stay engaged with the user's teeth to effectively brush that surface of the user's teeth.

FIG. 2L a brush-head having bristles on a reverse side, according to some embodiments. In some embodiments, the brush-head 240 includes bristles 244 for cleaning a biting surface of the user's opposite jaw, that is, the brush-head 240 includes bristles 242 that can be located on a reverse side of the brush-head 240. FIG. 2L shows a spring feature 244 for the brush-head 240, but in other embodiments, the brush-head 240 may not include such a spring feature 242. The Bristles 244 are shown facing an opposite direction to bristles 246 of the brush-head 240. For example, the bristles 246 can be the same or similar to the bristles 203 described for FIG. 2C.

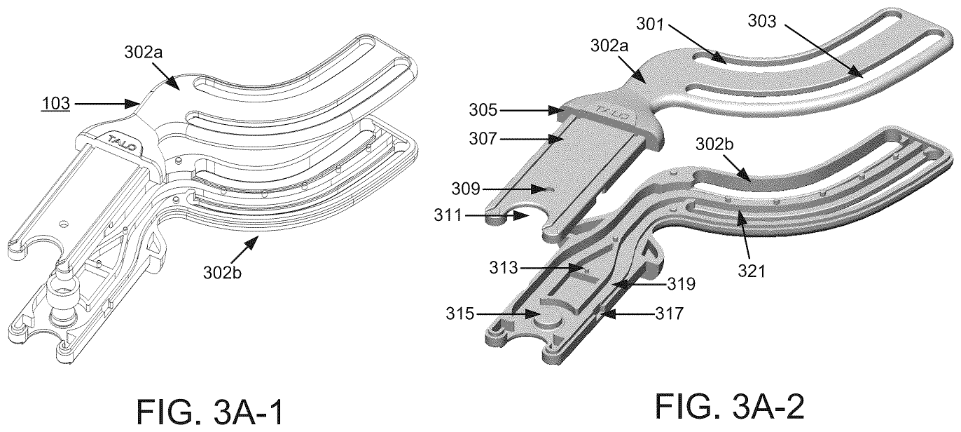

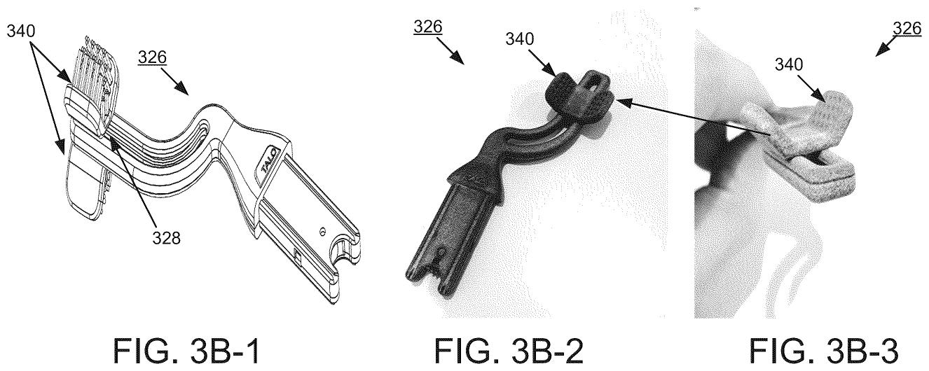

FIGS. 3A-1, 3A-2 illustrates different views of an exemplary mouthpiece, according to some embodiments of the disclosure. FIGS. 3A-1 and 3A-2 can collectively be referred to herein as FIG. 3A. A mouthpiece 103 is shown that can include two separate pieces 302a, 302b, which when combined together allow a driven belt to hide inside the mouthpiece 103. According to one embodiment, a first piece 302a (e.g., a top piece in the illustrated right part of FIG. 3A-1, 3A-2) includes an inner track 301, an outer track 303, a seal 305, an alignment track 307, a detent catch 307, and a gear window 309. A second piece 302b (e.g., a bottom piece in the illustrated right part of FIG. 3A-1, 3A-2) includes certain alignment posts 313 (which can match certain holes in the first piece (not shown)), a bushing axle 315 (which can match the detent catch 309 in the first piece), and a latch catch 317 (which can match a latch in the first piece). As also illustrated in FIG. 3A, the lower piece 302b can include a belt track, as indicated by 319 and 321, which can hold different sections or a belt (not shown). Although not shown, the first piece 302a can also include the belt track. Alternatively, the first piece 302a can not include a belt track, and instead includes a flat surface that covers the belt track provided in the second piece 302b.

It is to be noted that the mouthpiece 103 shown in FIG. 3A includes two tracks, that is, the inner track 301 and the outer track 303, and thus can be referred to a double track version of mouthpiece. In some embodiments, there is only one track included in a mouthpiece. A mouthpiece within one track can be also referred to as a single track version of the mouthpiece.

FIGS. 3B-1, 3B-2, 3B-3 illustrate a single track version mouthpiece, according to some embodiments. FIGS. 3B-1, 3B-2, and 3B-3 can collectively be referred to herein as FIG. 3B. In some embodiments, the single track mouthpiece 326 can include a belt end 328 having brush-heads 340 connected to the belt end 328 (instead of each brush-head on different ends of a belt). The configuration shown in FIG. 3A can allow for both brush-heads 340 to move together instead of in opposite directions. The configuration shown in FIG. 3A can provide a more comfortable brushing experience since it can allow the user to close their mouth more while the brushes of the brush-heads 340 are brushing the user's front teeth.

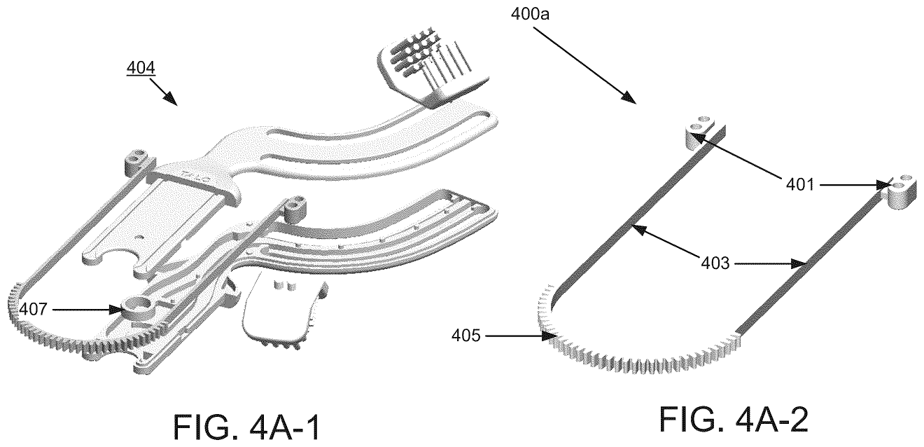

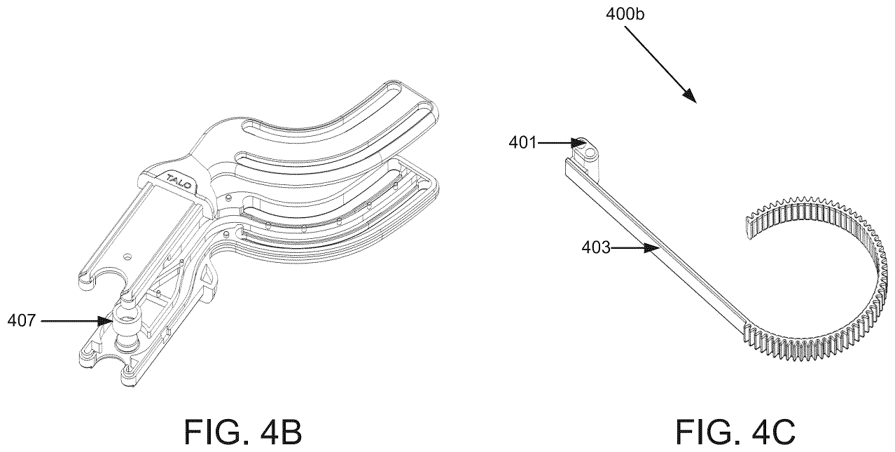

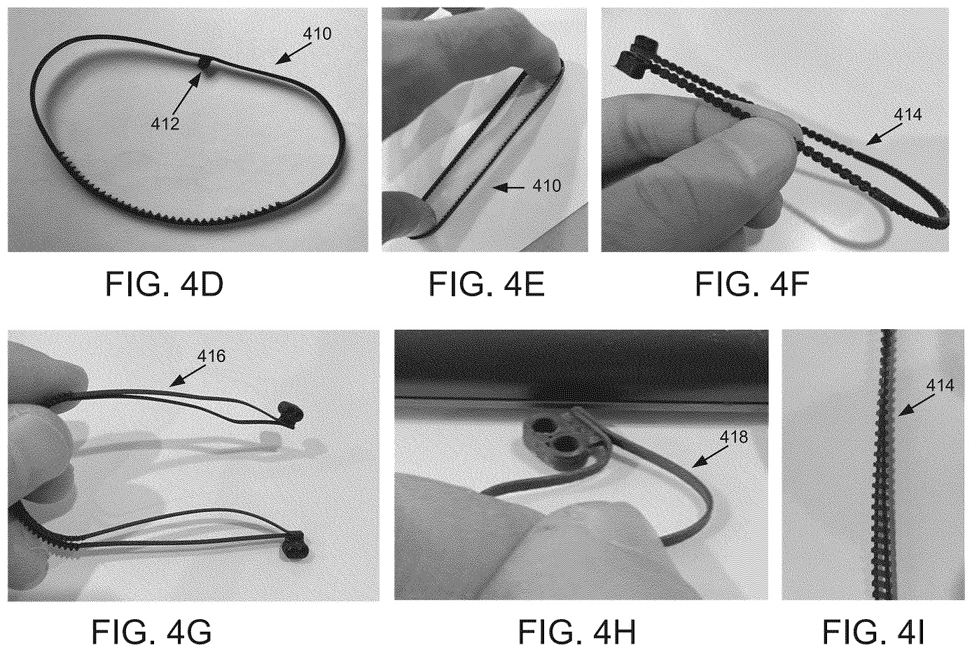

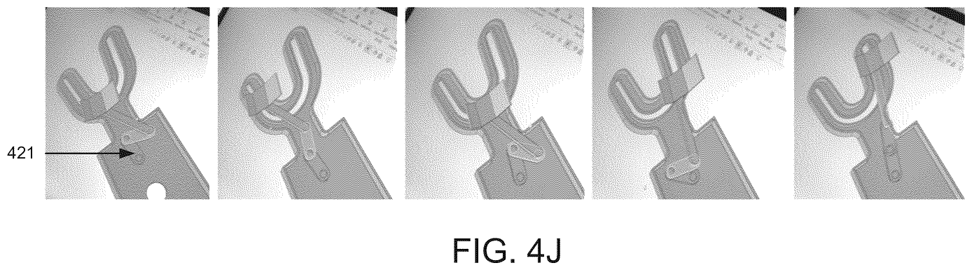

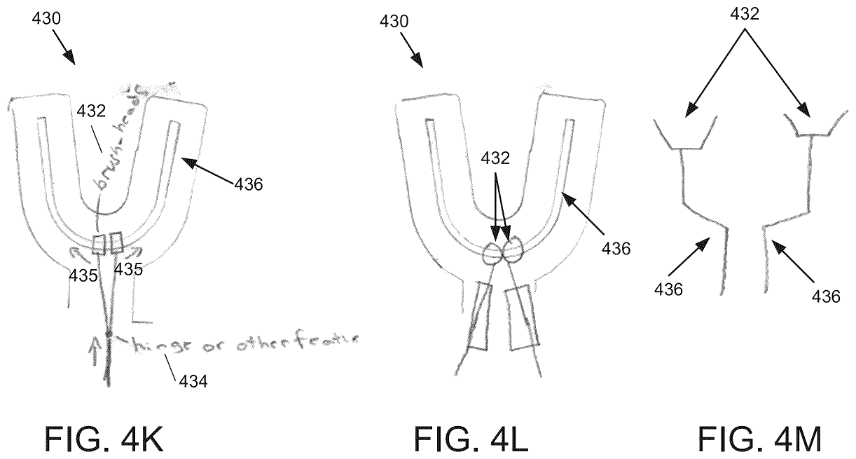

FIGS. 4A-1, 4A-2 illustrate an exemplary belt 400a for a mouthpiece 404 according to some embodiments of the disclosure. FIGS. 4A-1 and 4B-2 can collectively be referred to herein as FIG. 4A. The belt 400a can include a pair of brush connection units 401, a pair of smooth regions 403, and a central geared region 405. The geared region 405 can engage with a bushing or bearing 407 for driving the belt to move, which then simultaneously moves the brush-heads attached to the belt through the brush connection units 401. The bushing (or bearing) can be rotatably fixed to the bushing axle 315 in the second piece of mouthpiece shown in FIG. 3A.

It should be noted that, while the belt shown in FIG. 4A includes two connection units, in some embodiments, a belt can include only one connection unit 401, which can be proper for a single track version of mouthpiece configured with only one brush-head attached thereto, or for a mouthpiece configured with two brush-heads attached to a connection unit 401.

FIG. 4B illustrates an exemplary bearing structure for a mouthpiece, according to some embodiments. In some embodiments, FIG. 4B shows an example bushing/bearing structure 407 for the mouthpiece 404 from FIG. 4A. In some examples, bushing inside the mouthpiece 404 can allow for reduced friction between the belt 400a and the mouthpiece 404 as the belt 400a rubs back and forth at a turn and/or at the point of contact of the belt 400a with gears of a handle of the mouthpiece 404.

FIG. 4C illustrates an exemplary belt for a mouthpiece, according to some embodiments. In some embodiments, the belt 400b includes a connection unit 401. In some examples, the belt 400b can include a single connection unit 401. As illustrated in FIG. 4C, the belt 400b can include a smooth region 403.

It should be also noted that, while FIGS. 4A-4C illustrate some open-ended belts, in some embodiments, the belts for the disclosed toothbrush can be in other different forms, such as close-ended belts. In addition, in some embodiments, a chain based mechanism can be used instead. In other embodiments, substitute electromagnets, gears, pneumatic pressure or suction to the individual brush-heads under electronic power and control of the logic and embedded programming implemented in electronic components can be used.

FIGS. 4D-4I illustrate other exemplary belts for a mouthpiece, according to some embodiments. As described herein belts can also be referred to as chains, among other terms. In some embodiments, FIG. 4D and FIG. 4E illustrate two exemplary close-ended belts and/or closed loop belts 410. The belts 410 can include a connection unit 412, which can be used for a two brush-head configuration that moves together. In one example, the belts 410 can include one connection unit 412, e.g., belts 410 include a single connection unit. In some examples, FIGS. 4F and 4I illustrate an exemplary roller chain and/or roller belt 414. Features on the belt 414 can improve flexibility to a connected brush-head, and allow for incorporating an additional axis of motion (up/down) to the brush-head in addition to side-to-side movement since the belt 414 provides more flexibility to bend upwards/downwards. FIG. 4G illustrates an example two-layer belt 416, which can include single belt with a feature that has a detached layer as a part of the belt. The detached layer can include a 2^{nd} detached layer. This feature can be used for flexibility, additional axis of motion, pivoting, etc. FIG. 4H illustrates another example two-layer belt 418, which shows how the belt 418 can absorb certain motion, allowing for pivoting of an attached brush-head, etc.

FIG. 4J illustrates an example driving mechanism for a mouthpiece having a linkage and/or armature, according to some embodiments. As illustrated in FIG. 4J, instead of using a belt, arms and/or linkages are used to drive a brush-head to move around the track. For example, as indicated by arrow 421, as the center is driven by a motor included in the handle, it can cause the arms and linkages to move accordingly to either side, which then allows the brush-head to move along the track, as illustrated in FIG. 4J.

FIGS. 4K-4M illustrate exemplary linkages and/or arms, according to some embodiments. In some embodiments, a mouthpiece 430 having brush-heads 432, a hinge 434 and a track 436 are shown. In some examples, the brush-heads 432 start and move in opposite directions 435 (i.e., starting in the center or front teeth and moving towards the back molars). In the image shown in FIG. 4K, there is a hinge 434, which can be driven up and down, which then causes the linkage/armature to pass through a pivot or separation point such that the two brush-heads 432 are forced to move along the track 436 they are attached to. In the images shown in FIGS. 4L-4M, different mechanisms are further illustrated. For example, as one side is pushed up and down from the bottom, it can cause the brush-head 432 from the corresponding side to move following a path on the track.

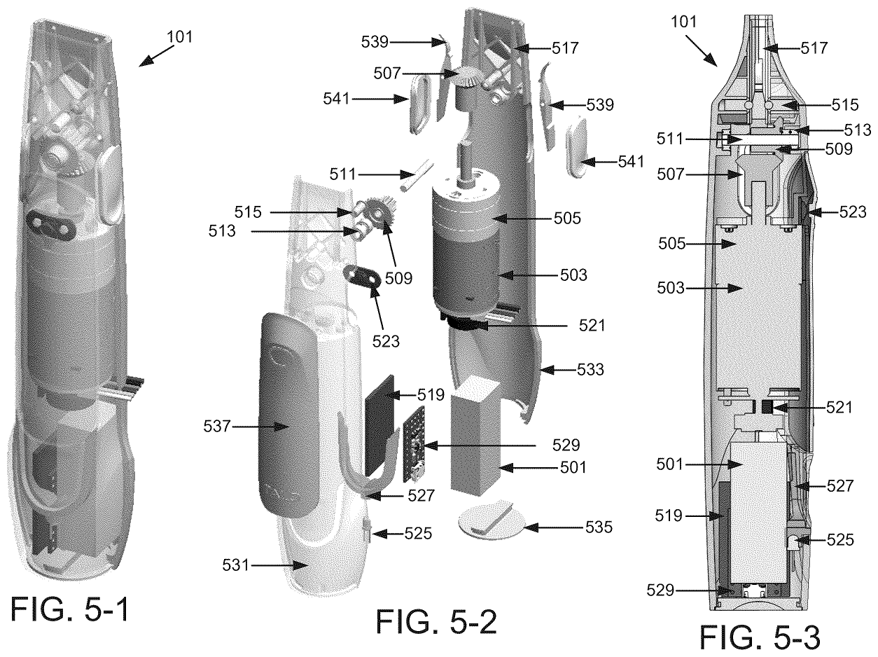

FIGS. 5-1, 5-2, and 5-3 illustrate an exemplary handle for a toothbrush and/or mouthpiece, according to some embodiments. In some embodiments, FIGS. 5-1 and 5-2 respectively show an integrated 3-D view and a cross-sectional view of an integrated handle 101. FIG. 5-3 illustrates an exploded view of the toothbrush handle 101, according to some embodiments. FIGS. 5-1, 5-2, and 5-3 2 can collectively be referred to herein as FIG. 5.

As illustrated, the handle 101 includes a power supply, such as a battery 501, for providing the power to the automated toothbrush, such as for activating the brush-heads to brush the teeth and for driving the belt to navigate the brush-heads along the cartridge. The power supply 501 can also provide power for other components in the powered toothbrush, such as lighting elements, controlling elements, sensing elements, etc. According to some embodiments, the power supply or battery 501 can be located at a lower part of the handle, as shown in right image of FIG. 5. The battery can be a rechargeable battery that can be charged through a wired or wireless charge.

The handle 101 further includes an electric motor 503 that can be used as a power transfer mechanism to drive the brush-heads to activate to brush teeth and to navigate along the cartridge. Associated with the motor-to-action, the handle 101 can further include gear box 505, spur gear 507, comb gear 509, gear shaft 511, ball nose plunger 513, and bearings 515. The bearing 515 can be the bearing 407 described in FIG. 4A. In addition, as shown in top part in the middle image, the handle can further include mouthpiece tracks 517, as described above in FIGS. 4-5.

Besides the mechanical units described above, the handle 101 additionally include certain controlling units, lighting units, and other electronic units. For example, the handle 101 can further include a motor controller 519 and an encoder 521 coupled to the motor 503, and include power button 523 to turn on/off the brush, and LED light 525 and light pipe 527 for facilitating the display of the operation modes and/or battery conditions, etc. In addition, the handle 101 can further include a processor 529 where certain programs can be installed for facilitating the smart control of the toothbrush. For example, the programs 529 can include logic or algorithms for adjusting brushing motions based on the user teeth conditions and user preferences. The user teeth conditions can be determined based on certain sensors (not shown) included in the toothbrush, or based on information provided by the user or dentist. The user preferences can be determined based on the user inputs or actual teeth brushing processes. Although not illustrated, the handle can include one or more communication units for setting up wired or wireless communications. This can allow the toothbrush to obtain user data and other information through wired or wireless communication. In one example, the communication units can set up a wireless communication between the toothbrush and an app installed on a mobile device such as a mobile phone, which can allow the user to define the teeth conditions, which can be sent to the toothbrush for adjusting the brushing motions based on the teeth conditions provided through mobile phone app.

Besides the different mechanical and electronical units, the handle 101 can include additional structural components, such as front cover 531, rear cover 533, bottom cap 535, and grip 537. Other structural components can include but not limited to release latch 539 and release button 541, which can help release the mouthpiece for replacement purposes or for other purposes.

It should be noted that the configuration shown in FIG. 5 is just one example of the disclosed toothbrush handle 101. The disclosed toothbrush can take other different configurations, as will be described more in detail later.

FIGS. 6A-1 and 6A-2 illustrate an exemplary mechanism for a driving belt, according to some embodiments.

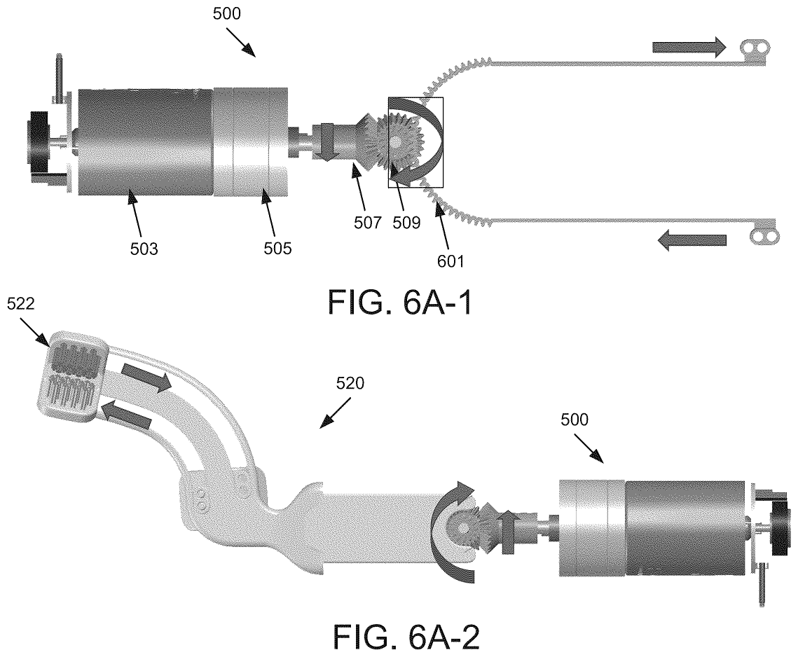

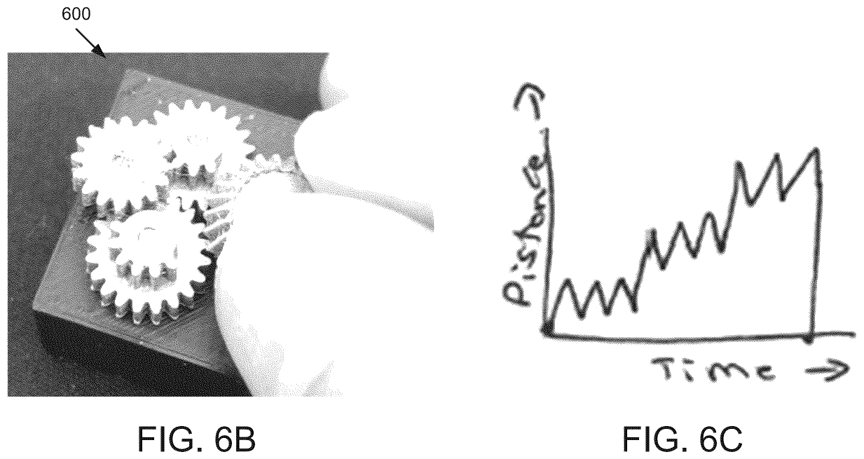

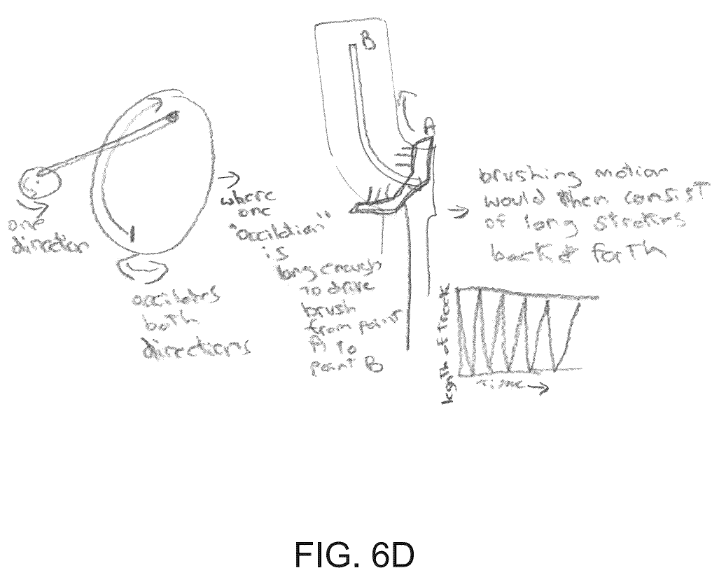

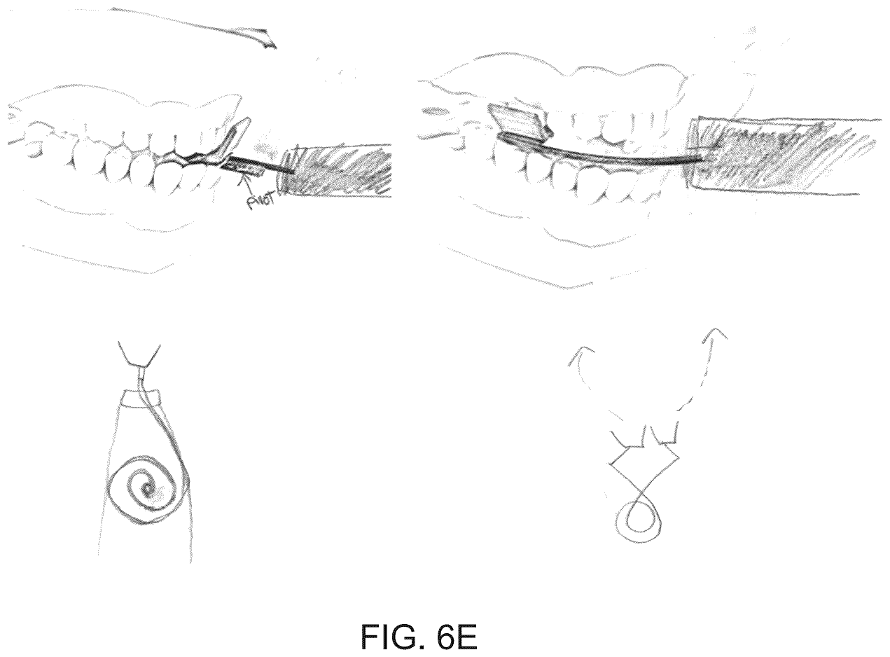

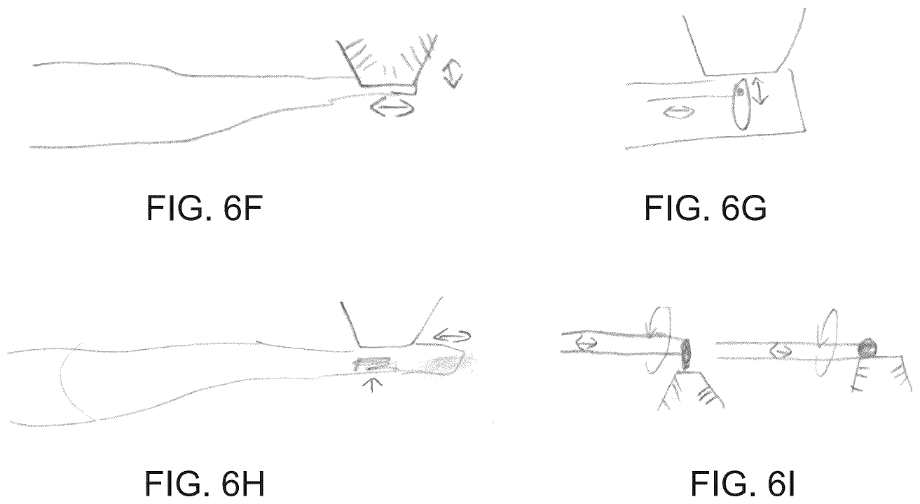

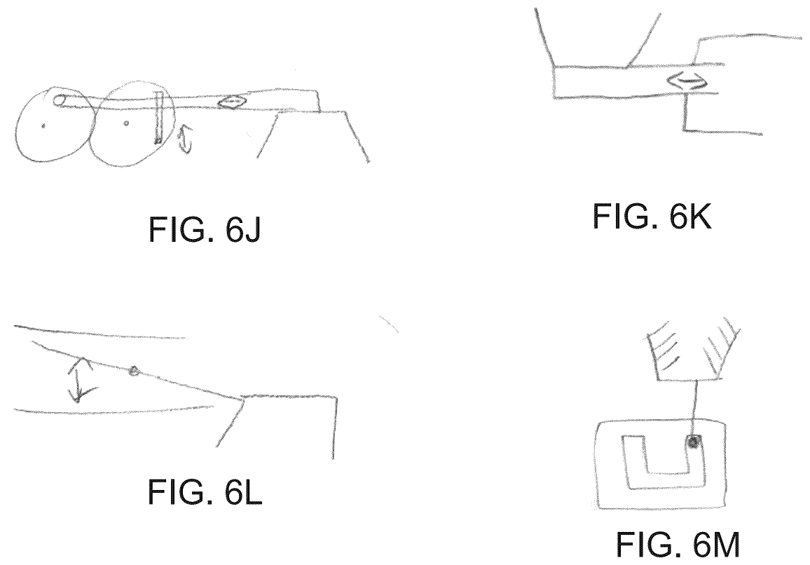

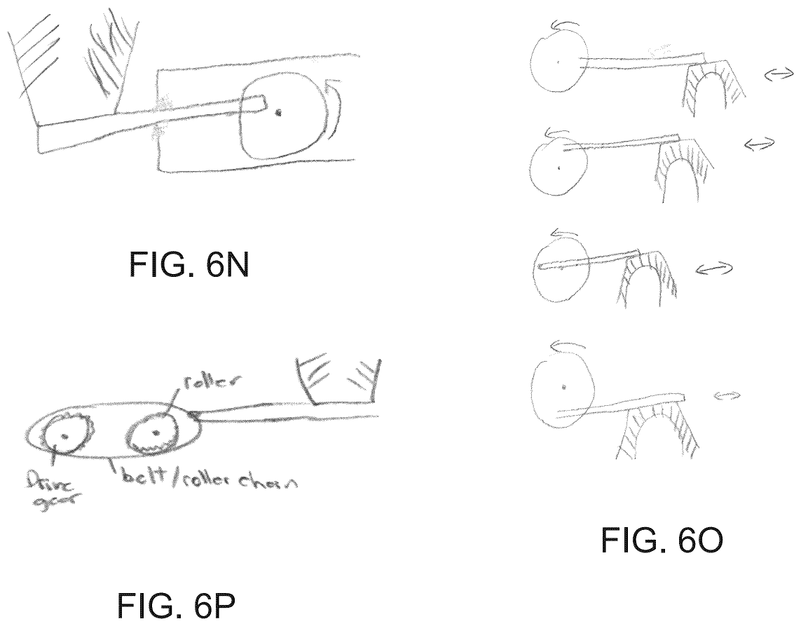

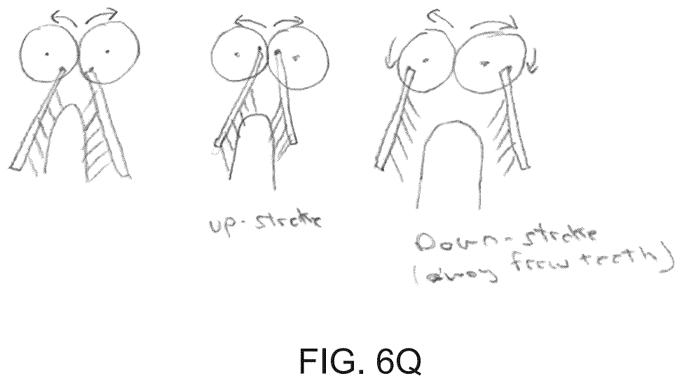

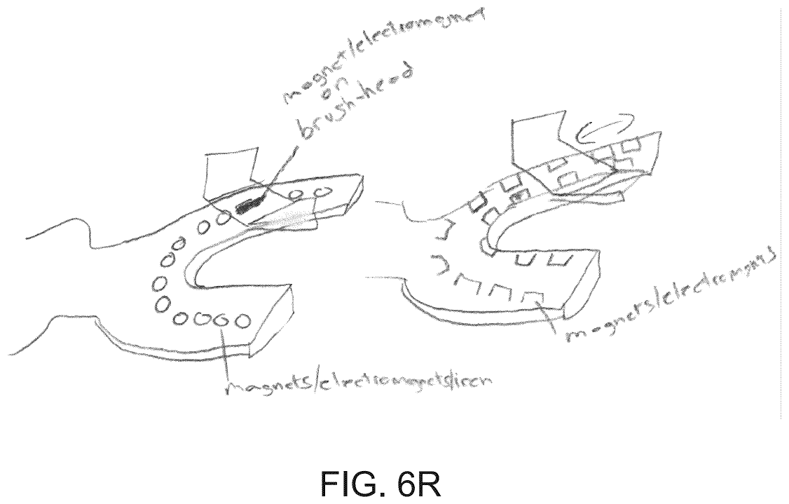

FIG. 6A-1 illustrates a mechanical configuration 500 for a drive belt, according to some embodiments. The mechanical configuration 500 includes a gear box 505 that can be driven to rotate by an electrical motor 503, which then drives a spur gear 507 to rotate. The rotation of the spur gear 507 further causes a comb gear 509 to rotate, which then drives a belt gear teeth to rotate, thereby moving the belt along one direction. To allow the belt to move along another direction, the rotation direction of the motor 503 can be changed, which drives the spur gear 507 and comb gear 509 to rotate along an opposite direction (e.g., from clockwise to anti-clockwise, or vice versa). In some embodiments, an encoder on the motor can be used for real-time feedback so the brush can stay on the tooth that is supposed to be at, or move the brush-head in a pre-determined position.

FIG. 6A-2 illustrates a J-shaped mouthpiece 520 attached to the mechanical configuration 500 of FIG. 6A-1, according to some embodiments. The J-shaped mouthpiece 520 can be referred to as a mouthpiece 520. The mouthpiece 520 can include a brush-head 522 at one side (e.g., a top side shown in the figure) that can be driven to move towards a distal end (i.e., an end away from the handle) of the mouthpiece 522. At the same time, the bottom brush-head (not shown) can be driven to move toward a proximal end (i.e., the end adjacent to the handle) of the mouthpiece 522.

FIG. 6B illustrates a mechanism for converting rotational motion to oscillating motion, according to some embodiments. For example, FIG. 6B illustrates a mechanism for converting a continuous rotational input from a motor to an oscillating back and forth motion. In some embodiments, a motor drives a belt by quickly switching directions back and forth and then advancing, creating the desired oscillation motion and controlled/monitored through an on-board encoder. After oscillating on a tooth, it advances the motor forward to the next tooth. Such a motion works to achieve the expected functions, but it also has certain drawbacks. Alternatively, a motion mechanism can have a motor run in just one direction and have that mechanically changed from one-directional rotational motion to an oscillating back and forth motion. There are various means of doing this, such as a scotch yoke mechanism etc. However, in these different means, it can provide the “brushing” motion, and it would still require additional motion to advance the brush-head down the track from tooth-to-tooth, otherwise the brush will just be brushing in the same spot continuously. In the disclosed embodiments, there are various means of adding a motion mechanism or an additional motor to provide for an additional movement to also control which tooth a brush-head is brushing. In one example, mechanisms such as scotch yoke mechanism or a crank/slider mechanism can be paired with some additional feature or a second motor for driving the belt from tooth-to-tooth.

One such embodiment illustrated in FIG. 6B includes a set of gears 600 where a continuous rotational input from a motor is converted to oscillating back and forth motion. In the illustrated embodiment, one gear has an extra tooth, such that as the gear oscillates back and forth, it will also advance the brush. The main advantage of such motion mechanism that the motion is smoother and less jerking, since the motor is not stopping and reversing repeatedly and more powerful. Another advantage would be less heat/wear on the motor. This configuration prevents and/or substantially reduces an amount of torque/speed that can be lost by oscillating the motor back and forth (quick starting/stopping of motor).

FIG. 6C illustrates an example graph illustrating the motion created from the input of a continuous rotational motion, according to some embodiments. As illustrated in the graph, the motion includes both oscillating motion and advancement motion.

FIG. 6D illustrates an exemplary brush-head oscillating mechanism, according to some embodiments. In some embodiments, FIG. 6D shows an alternate method that only uses an oscillating mechanism. The alternative oscillating mechanism can be a scotch yoke mechanism or another different mechanism that converts the motor's rotary motion into an oscillating motion, where the oscillating motion is the entire length of track, such that the brush just brushes back and forth in long strokes, but no further mechanism is needed to ‘advance’ the brush, since the brush travels the entire length of track with each stroke. For example, as illustrated in the figure, the motor drives the brush-head to oscillate in both directions, where one oscillation drives the brush-head to move from point A to point B. That is, the brush motion consists of a back-and-forth motion across the entire length of track.

FIG. 6E illustrates an example mouthpiece with no track, according to some embodiments. That is, there is no fixed track in a mouthpiece. Instead, a brush-head is attached to a belt or armature with a similar style as a track. This can also allow the brush-head to generate the desired motion and follow the curvature of teeth during a brushing process.

FIGS. 6F-6N illustrate various alternate form factors, according to some embodiments. Variations of a brush that moves around the teeth are described. According to some embodiments, disclosed herein also includes a form factor that has the same brush-head, but a user needs to glide along the teeth, and the powered brush does the rest of the work. Any previous embodiment of brush-head or other existing powered brushes can be used in this form factor. In the disclosed embodiment, the brush-head can be able to pivot and/or be on ball-joint, or other means of pivoting the handle from the mouthpiece that houses the brush-head to more easily go around the mouth and a curve the user's teeth.

FIG. 6F illustrates an exemplary brush-head that is directly attached to a handle, according to some embodiments. For example, FIG. 6F illustrates an example brush-head that is directly attached to a handle, according to some embodiments. In some examples, the brush-head can be attached to the handle and oscillate back and forth.

FIG. 6G illustrates an offset gear and a shaft used to generate motion of a brush-head, according to some embodiments. In some embodiments, FIG. 6G shows an example form factor in which shows an offset gear or oval gear and a shaft to generate up/down motion and side-to-side motion, according to some embodiments. This can be achieved in different ways. In one example, as shown in the left part of FIG. 6I, an alternate showing shaft can move back and forth within the handle, and/or rotationally move offset cam, as shown in the image.

FIG. 6H illustrates a brush-head using a cam or bump feature to provide an axis of motion, according to some embodiments. In some embodiments, FIG. 6H shows a brush-head portion that can use a cam or bump feature to cause an additional axis of motion (up/down motion) as the brush-head oscillates side-to-side.

FIG. 6I illustrates as shaft moving rotationally, according to some embodiments. In some embodiments, referring to the right part in FIG. 6I, a shaft moving rotationally is used to convert a motion into a back-and-forth motion of the brush-head.

FIG. 6J illustrates an exemplary brush-head showing a drive gear operation, according to some embodiments. In some embodiments, FIG. 6J shows a drive gear operation to generate one or both motions of a shaft (up/down) and/or side-to-side.

FIG. 6K illustrates an exemplary brush-head that moves in and out of a handle, according to some embodiments. In some embodiments, FIG. 6K shows a brush-head that moves in and out of a handle.

FIG. 6L illustrates an exemplary brush-head that uses a pivoting arm to generate motion. In some embodiments, FIG. 6L shows using a pivoting arm to generate a motion for use with the brush-heads described herein.

FIG. 6M illustrates an exemplary brush-head operable to move along a micro-track within the mouthpiece, according to some embodiments. In some embodiments, FIG. 6M shows a brush-head that can be moved along in a micro-track within the mouthpiece, such that the brush produces a motion to be used with the brush-heads described herein.

FIG. 6N illustrates an example showing brush-head motion converted to rotational motion, according to some embodiments. In some embodiments, FIG. 6N shows a motion for a brush-head that is converted to a rotational motion when a wheel is rotated, similar to what is illustrated in FIG. 6O. Or it can be converted to a reciprocating linear motion if the size of the opening where the brush-head comes out is limited or similar feature to convert it just to linear.

FIG. 6O illustrates an example showing brush-head up and down motion generated by a linkage, according to some embodiments. FIG. 6O shows of a linear motion of a brush-head and an up/down motion of the brush-head can be generated when a linkage is connected and used. The linkage can make an overall motion of the brush-head similar to a rotational motion.

FIG. 6P illustrates an example showing a chain or belt for a brush-head that is driven around a gear/gasket, according to some embodiments. In some embodiments, FIG. 6P shows an example showing a chain/belt that is driven around a gear/gasket. That is, instead of a direct connection on a gear/wheel, brush-head mechanism can be attached to a flexible chain/belt that is driven around a gear/sprocket. The configuration shown in FIG. 6P can add additional flexibility in creating different motion.

FIG. 6Q illustrates an exemplary brush-head having two opposing gears, according to some embodiments. In some embodiments, FIG. 6Q shows an example brush-head that itself can have two opposing gears that cause the sides of the brush to lift up and down, but backing away from the teeth in the downward stroke motion. In this way, it can be more gentle for the gums. This is basically creating up/down axis of motion, but less engagement with teeth gums on downward stroke.

FIG. 6R illustrates an exemplary brush-head driven by an electromagnet, according to some embodiments. In some embodiments, FIG. 6R shows an example brush-head driven by electromagnet instead of mechanical motion. That is, one or more magnets/electromagnets/electromagnetic coils are used to create a magnetic propulsion system inside a track that serves to drive the exterior brush-head along the track. In one example embodiment, the exterior brush-head wraps around the track and has a magnet/electromagnet/iron or other material attached, capable of being driven from the internal propulsion system. The system can switch polarities or alternate magnets receiving power, so as to drive brush-head and/or switch directions. The advantages of this system include less friction, being able to have an entirely closed cartridge system to prevent water/toothpaste to get in, not having mechanical moving pieces that could break. This configuration can be used to create not only back-forth motion, but also up/down, circular or other motion for different brushing/cleaning actions. In some embodiments, the configuration shown in FIG. 6R can allow to combine a regular belt-driven system with magnets/electromagnets to add in up/down motions. This can be done with or without electromagnets by using regular magnets to repel/attract brush-head to create up/down motion together with the standard belt-driven system.

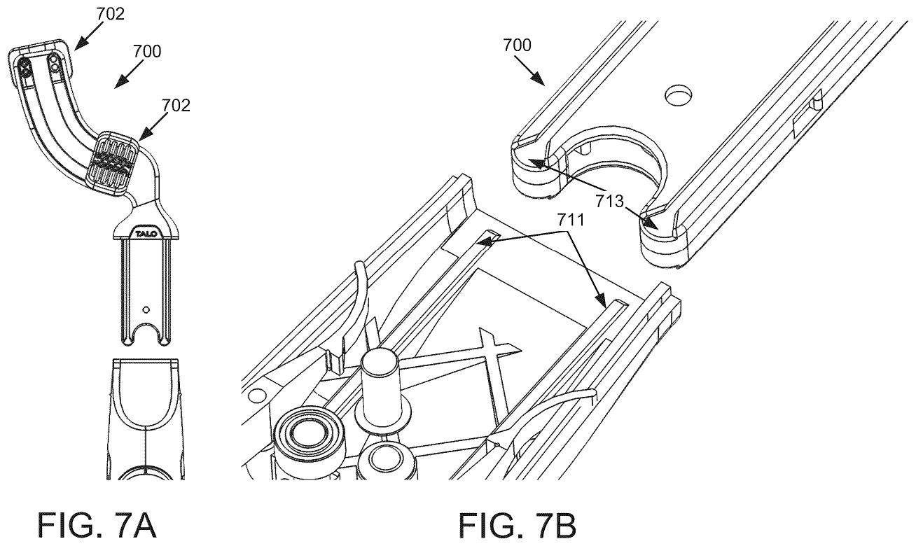

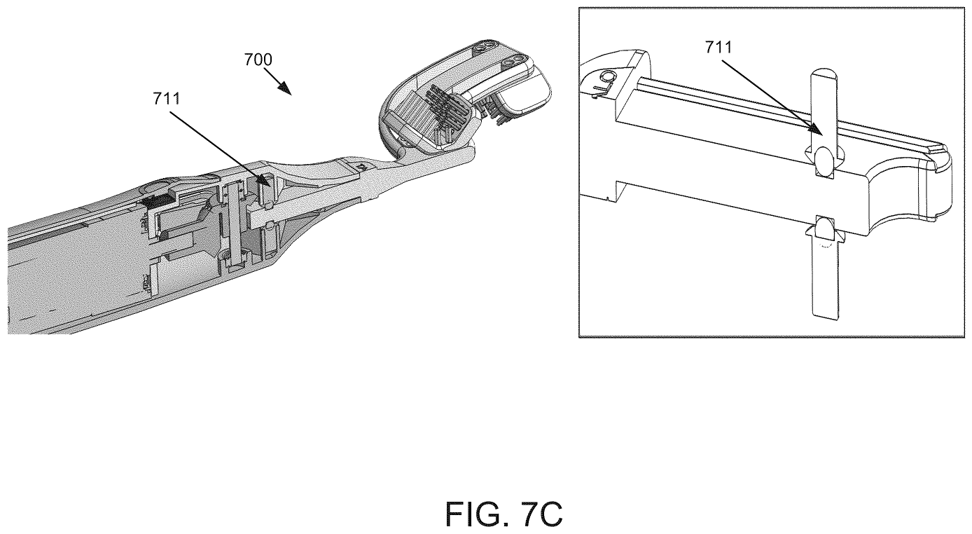

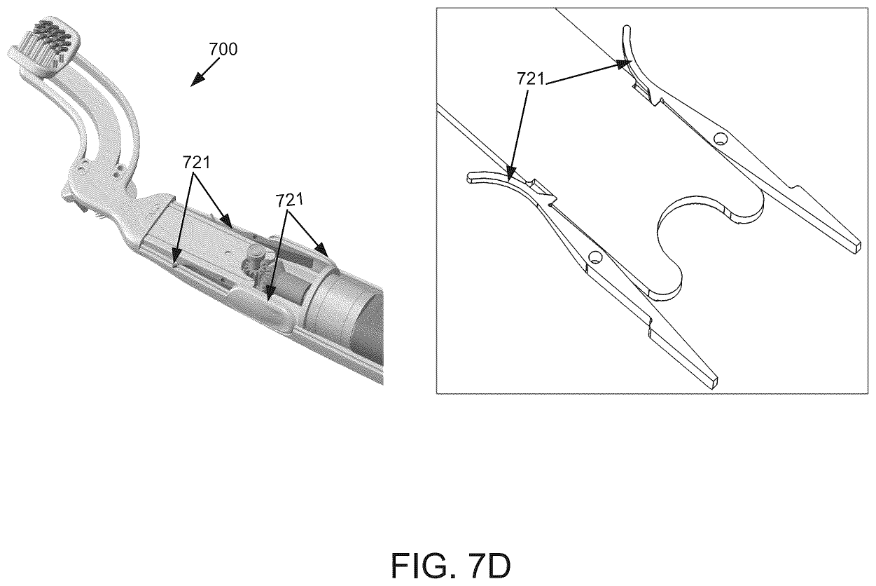

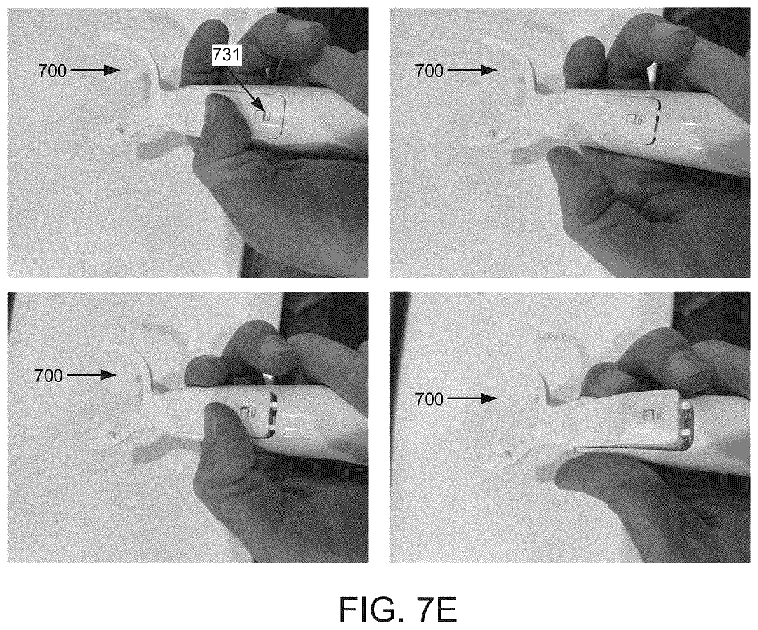

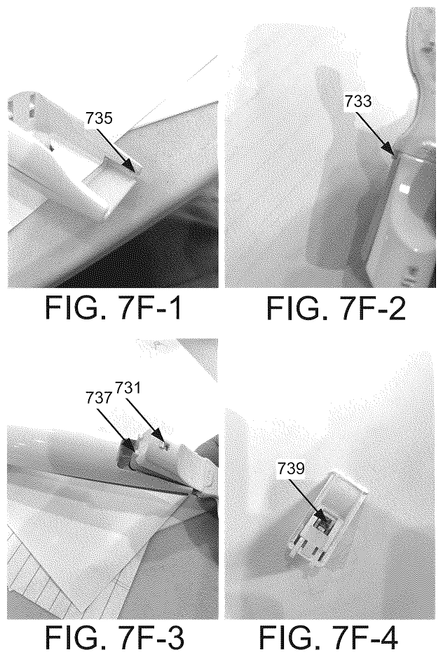

FIG. 7A illustrates an example removable mouthpiece, according to some embodiments. As illustrated in the figure, the mouthpiece 700 can be removable, and thus can be easily cleaned and replaced if it does not work. As illustrated in the figure, the brush-heads 702 can be also removable and replaceable. This also allows to the brush-heads 702 to be periodically replaced to prevent breakage from ware and contamination from prolonged use.

FIG. 7B illustrates example guides for an end user to connect/disconnect and replace a mouthpiece, according to some embodiment. As illustrated, the guides include a pair of guide bars 711 fixed onto a handle and a pair of alignment tracks 713 configured in a removable mouthpiece 700. The guide bars and the alignment tracks together can aid in the mouthpiece 700 stability and the assembly alignment.

FIG. 7C illustrates an example retention mechanism for attaching a mouthpiece to a handle, according to some embodiments. As illustrated in the left and right images in the figure, the handle can include a pair of ball detent plungers 711 that can be pushed into a pair of detents carried by the mouthpiece 700 (i.e., the handle part of the mouthpiece). The ball detent plungers 711 can be spring-loaded, and thus the retention by the ball plungers can require an overpowering pull-out force to overcome the spring-loaded ball plungers.

FIG. 7D illustrates another example mechanism for attaching a mouthpiece to a handle, according to some embodiment. As illustrated in the two images, a pair of spring-loaded latches 721 can be used to lock the mouthpiece 700 into the handle, which can also require force to decouple the mouthpiece from the handle. For such purposes, a pair of release buttons 723 can be configured on two opposite sides of the handle for releasing the mouthpiece 700 as needed.

FIG. 7E illustrate another example mechanism for attaching a mouthpiece to a handle, according to some embodiments. As illustrated in the images in FIG. 7E, a slider 731 can be configured for retention of a mouthpiece 700 to a handle. The slider 731 can be pushed town (toward the bottom of the handle) to lock the mouthpiece 700 to the handle, or the slider 731 can be pushed up to tilt the mouthpiece 700 back to release the mouthpiece 700.

FIGS. 7F-1, 7F-2, 7F-3, and 7F-4 illustrate another example mechanism for attaching a mouthpiece to a handle, according to some embodiments. FIGS. 7F-1, 7F-2, 7F-3, and 7F-4 can collectively be referred to herein as FIG. 7F. Compared to the attaching mechanisms described earlier, in the illustrated embodiment in FIG. 7F, the cartridge does not slide down into the handle and isn't being inserted inside the handle. Specifically, as illustrated in FIGS. 7F-1 and 7F-2, there are a couple of guides 735 (on two sides of the mouthpiece) and lead-ins 735 that together guide the alignment between the mouthpiece and the handle. In some embodiments, these lead-ins and guides can also provide pivot points once engaged as shown in in FIG. 7F-1, which then allows the mouthpiece to be pivoted downwards to snap into the handle. In some embodiments, as shown in FIG. 7F-3, there can be a pair of locking features 737. When the spring-loaded slider is pressed and/or pushed upward to unlock the mouthpiece, the pair of locking features can retract to release disengage or unlock the mouthpiece for easy release. FIG. 7F-4 shows an inside view of the slider component. As can be seen, a spring is loaded, which can push the locking features out for locking the mouthpiece. In some embodiments, the attaching mechanism showing in FIG. 7F has benefits of having more stability (like a cassette tape), as the sprocket or gear inside the cartridge fully encloses/surrounds the drive gear in the handle, thereby forming a more solid connection. By locking the gear and cartridge in, it also helps prevent it from bouncing around or disengaging from the drive gear.

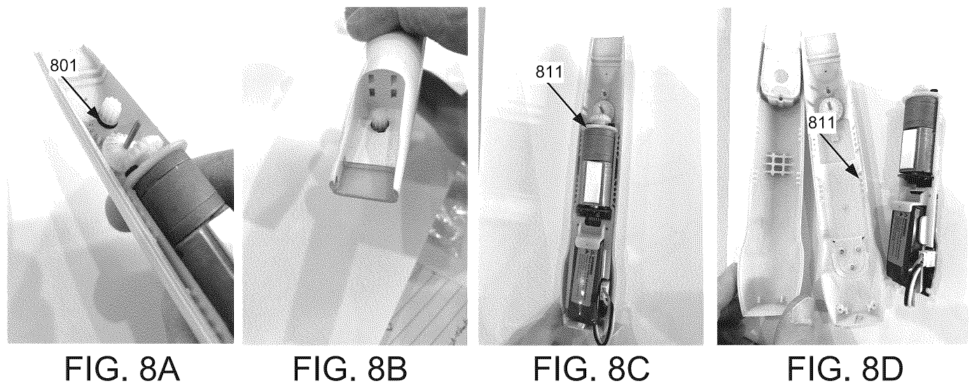

FIGS. 8A-8D illustrate various example views of a handle, according to some embodiments. Specifically, FIG. 8A illustrates an example inner view of a handle (covered part is removed), according to one embodiment. As illustrated in the figure, there is O-ring that can create a water barrier to prevent water to get into the handle to damage the electronic components included therein.

FIG. 8B illustrates an example handle with two parts closed together, according to some embodiments.

FIG. 8C illustrates another example inner view of a handle, according to some embodiments. As illustrated, there is also a “firewall” located inside the handle. When the two parts of a handle is sealed together, the firewall serves as an additional layer of block, keeping any moisture that can have gotten in from getting to motor/electronics, which can also be sealed (e.g., conformal coating for PCB etc.).

FIG. 8D illustrate another example inner view of a handle, according to some embodiments. As illustrated, there are some molded features on both sides in the handle, which are configured to support/lock in a chassis. When the chassis is placed inside handle, it can then automatically line up correctly with gears. The motor and other components attached to chassis can be then placed into the handle for easy and consistent assembly and accurate alignment.

In the following, certain other features for the disclosed powered brushes are further illustrated.

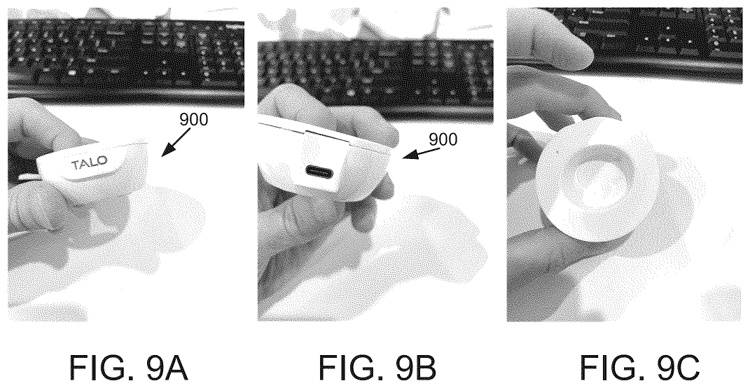

FIGS. 9A-9C illustrate example views of charging base, according to some embodiments. The charging base 900 can be an induction base, where the handle is placed inside the base. In some embodiments, to match the shape and design the handle disclosed herein, the charging base 900 can have an oblong shape to house the handle and keep it stable. In some embodiments, the charging base 900 can be in other different shapes and size, depending on the handle being configured.

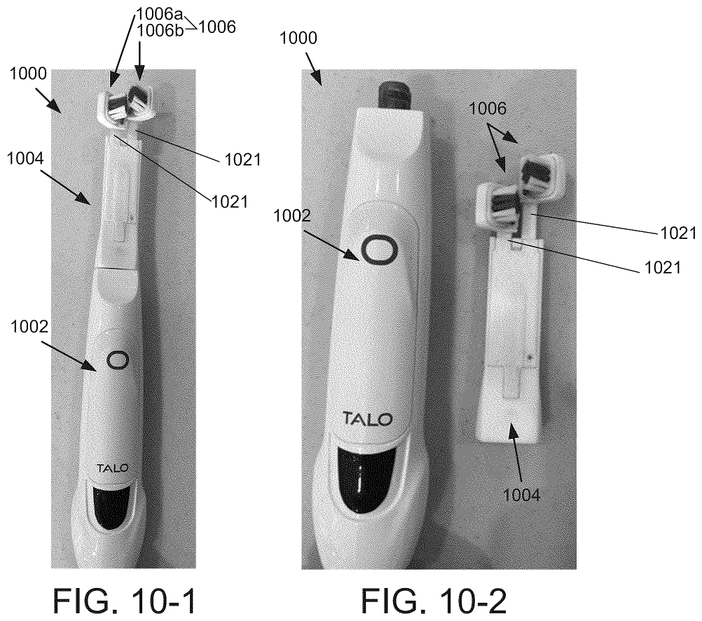

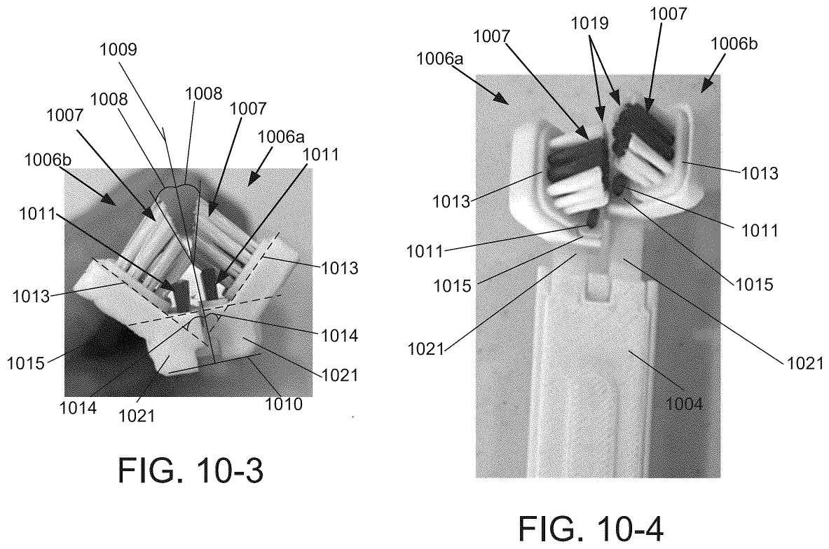

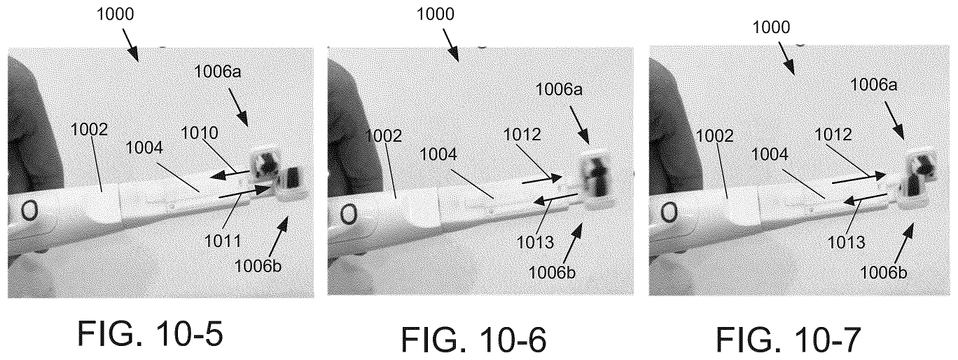

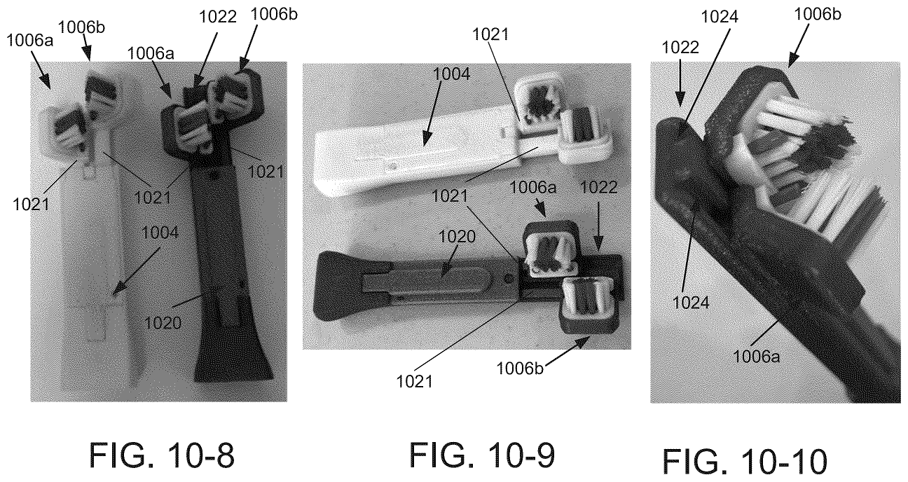

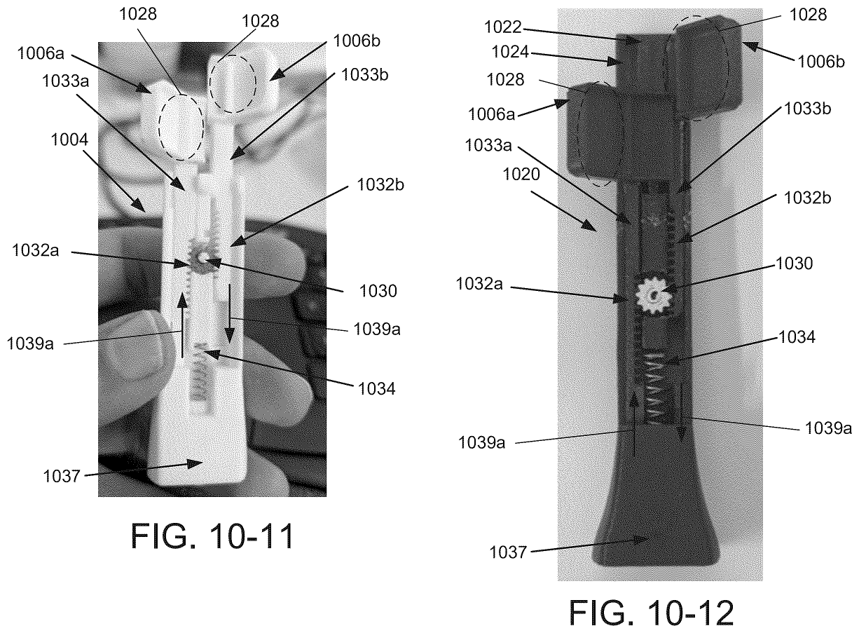

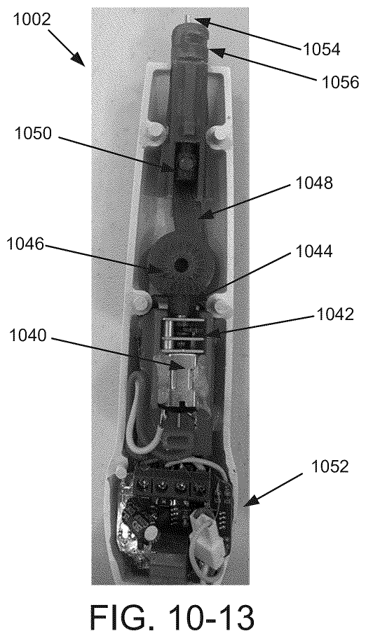

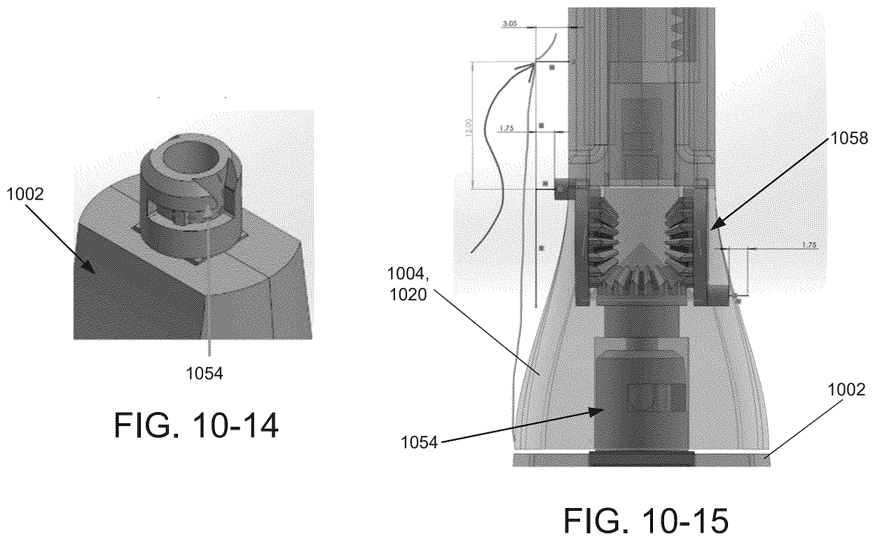

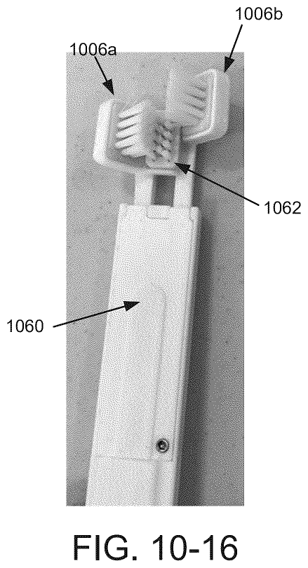

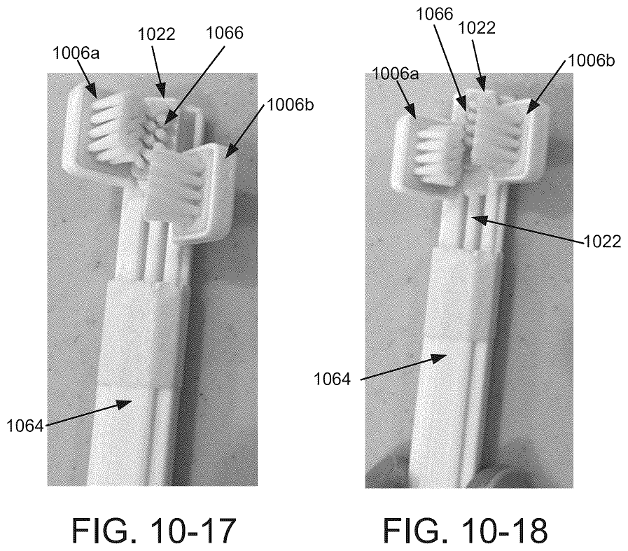

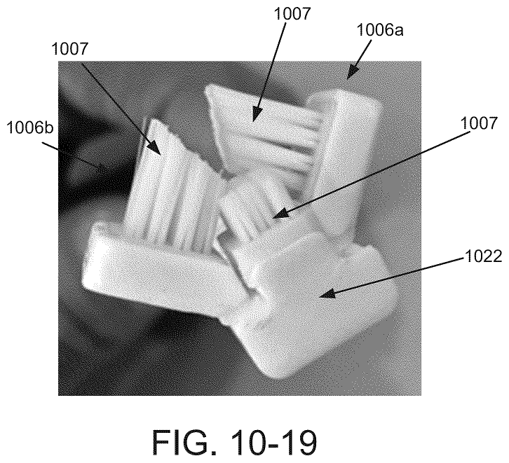

FIGS. 10-1, 10-2, 10-3, and 10-4 illustrate a teeth cleaning apparatus, according to some embodiments. FIGS. 10-1, 10-2, and 10-3 can collectively be referred to herein as FIG. 10. In some embodiments, the teeth cleaning apparatus 1000 can include a reciprocating side-by side teeth cleaning apparatus. In some examples, the teeth cleaning apparatus 1000 can include a handle 1002 and brushing cartridge 1004. The brushing cartridge 1004 can include brush-heads 1006a, 1006b. The brush-heads 1006a, 1006b can collectively be referred to as brush-heads 1006. FIG. 10-1 shows the teeth cleaning apparatus 1000 fully assembled. FIG. 10-2 shows the brushing cartridge 1004 removed from the handle 1002. FIG. 10-3 shows the brush-heads 1006. During operation, the brush-heads 1006 move back-and-forth over one or more teeth of user. The brush-heads 1006 move back-and-forth as the user glides the apparatus 1000 along the user's teeth. The brush-heads 1006 move in opposite directions back-and-forth from each other. In some examples, the brush-head 1006a moves in an opposite direction to the brush-head 1006 during cleaning and/or operation. The brush-heads 1006 can include beams 1021 that can be semi-flexible. The beams 1021 can allow the brush-heads 1006 to spread open to adjust to different teeth, brushing all sides of the user's one or more teeth at a time. In some examples, the brush-heads 1006a, 1006b can have and/or be connected to the beams 1021. The beams 1021 can be flexible. The flexibility of the brush-heads 1006, e.g., via the beams 1021, allows for a brushing angle that is adapted effectively clean the user's teeth. The flexibility of the brush-heads 1006 provides for a controlled and adequate pressure to be applied onto a tooth of the user, and allows for cleaning all sides of the tooth at once. The teeth cleaning apparatus 1000 allows the user to brush their teeth in less than half the time. The teeth cleaning apparatus 1000 provides for improved tooth cleaning over conventional products and/or techniques by whole tooth coverage. In some embodiments, the brushing cartridges 1004 can conform to the user's dental arch. In some examples, the beams 1021 can be flexible and allow the brushing cartridges 1004 to conform to the user's dental arch. The brush-heads 1006 can be connected to the brushing cartridges 1004 via the beams 1021. In some embodiments, the teeth cleaning apparatus 1000 can be combined with the features described in FIG. 1A, and/or other exemplary mouthpieces described herein. In some examples, an arched mouthpiece, e.g., as shown in FIG. 1A, can be connected to the brushing cartridge 1004. In one example, the arched mouthpiece can include a transmission track that has one, two, or more cavities for receiving brush-heads 1006. The brush-heads 1006 can move, in some examples, in an up-and-down motion. In some examples, the brush-heads 1006 can be located on an upper side of the brushing cartridge 1004, e.g., as shown in FIGS. 10-1 to 10-4.

In some embodiments, the teeth cleaning apparatus 1000 can include a built in water-jet and/or water-pic feature. In some examples, the water-pic can jet and apply water to one or more teeth of the user while using the teeth cleaning apparatus 1000.

Referring to FIGS. 10-3 and 10-4, the brush-heads 1006 are shown, according to some embodiments. The brush-heads 1006 can include brush-heads 1006a, 1006b. Each of the brush-heads 1006a, 1006b can include bristles 1007, 1011. The bristles 1007 can extend from the brush-heads 1006a, 1006b from a plane 1013 at an angle 1008. The bristles 1007 can be shaped and/or cut at the angle 1008. The bristles 1007 can be attached to the brush-heads 1006a, 1006b from the plane 1013 and at an angle 1014. The angles 1008, 1014 can be measured from a plane 1009 that is perpendicular from a plane 1010 defined by the brushing cartridge 1004. The angles 1008, 1014 can be adapted to receive one or more teeth of the user. Bristles 1011 can be attached to the brush-heads 1006a, 1006b along a plane 1015. The plane 1015 can be parallel to the plane 1010. Bristles 1011 can be optional, e.g., in some embodiments, the brush-heads 1006a, 1006b do not include the bristles 1011. Referring to FIG. 10-4, the bristles 1007 can include a lead-in for the user's teeth at a front 1019 of the bristles (not shown). In some examples, the bristles 1007 can have a top 1019 trimmed to open up. For example, an angle or placement (e.g., see angles 1008 at FIG. 10-3) of the brush-heads 1006a, 1006b can form a “V” shape at an opening between the bristles 1007. The “V” shape and/or configuration at 1019 can help the user's teeth glide along the bristles 1007, e.g. allowing the brush-heads 1006a, 1006b to move and smoothly receive and clean front teeth (incisors) to wider molars of the user. In some examples, the lead-in at 1019 can allow the brush-heads 1006a, 1006b to have an improved transition between teeth.

Referring to FIGS. 10-5, 10-5, and 10-6 the teeth cleaning apparatus 1000 during operation are shown, according to some embodiments. In some embodiments, each of the brush-heads 1006a, 1006b (e.g., brush-heads 1006) can move opposite to one another during operation. FIG. 10-5 shows brush-head 1006a moving in a direction 1010 (e.g., at a position toward the brushing cartridge 1004 and/or handle 1002), and brush-head 1006b moving in a direction 1011 (e.g., at a position away from the brushing cartridge 1004 and/or handle 1002). The direction 1010, and 1011 can be opposite directions. FIGS. 10-6 and 10-7 show the brush-head 1006a moving in a direction 1012 (e.g., at a position away from the brushing cartridge 1004 and/or the handle 1002), and brush-head 1006b moving in a direction 1013 (e.g., at a position toward from the brushing cartridge 1004 and/or the handle 1002). The direction 1012, and 1013 can be opposite directions. In some embodiments, the teeth cleaning apparatus 1000 moving the brush-heads 1006a, 1006b in opposite directions provides a counterbalance to each brush-head 1006a, 1006b and can significantly reduce kick-back and/or a jerking movement of the brush-heads 1006a, 1006b that can occur during brushing. The teeth cleaning apparatus 1000 operation as shown provides a much smoother more controlled brushing experience in contrast to conventional devices and/or techniques. The teeth cleaning apparatus 1000 can provide for improved teeth cleaning by providing more traction during movement of the brushes 1006, where the bristles of the brush-heads 1006 can move more freely in comparison to other devices and/or techniques.

FIGS. 10-8, 10-9, and 10-10 illustrate a plurality of exemplary brushing cartridges, according to some embodiments. FIG. 10-8 shows the brushing cartridge 1004 from FIGS. 10-1 to 107 beside another exemplary brushing cartridge 1020. The brushing cartridge 1020 can be similar in construction to the brushing cartridge 1020 with the addition of a support structure 1022. In some embodiments, the brushing cartridge 1004 does not include the back support structure 1022. In some examples, the brush-heads 1006a, 1006b can ride, fit within and/or be received by channels 1024 of the support structure 1022. As described herein, the support structure 1022 can be referred to as a back support structure 1022. The brush-heads 1006a, 1006b can have and/or be connected to beams 1021. In some examples the beams 1021 are flexible and/or semi-flexible.

FIGS. 10-11 and 10-12 illustrate an opened up brushing cartridges 1004, 1020, according to some embodiments. In some embodiments, the brushing cartridges 1004, 1020 can include holders and/or receptacles 1028 for the brush-heads 1006a, 1006b, a gear and/or a circular gear 1030, linear gears 1032a, 1032b, shafts 1033a, 1033b, and springs 1034. The brushing cartridge 1020 can include a support structure 1022 having channels 1024. The shafts 1033a, 1033b can include metal shafts. The shaft 1033a can engage with a hook feature (not shown) which goes inside a bottom side 1037 of cartridges 1004, 1020 and engages with the handle of the apparatus. The shaft 1033a and hook feature drives the linear gear 1032a (left rack) up and/or down, which is connected through circular gear 1030 (pinion) to the linear gear 1032b (right rack) to go down and/or up, causing the brush-heads 1006a, 1006b to move 1039a, 1039b in opposite directions. In some examples, the configuration presented herein can provide for the brush-heads moving in opposite directions simultaneously. In some examples the direction 1039a can be away from the bottom side 1037, and the direction 1039b can be toward the bottom side 1037 as shown. In some examples, the direction 1039a, 1039b can be reversed, e.g., the direction 1039a can be toward from the bottom side 1037, and the direction 1039b can be away the bottom side. The spring 1034 is connected to the shaft 1033a and linear gear 1032a (left rack), pushing it in the downward position. The spring 1034 can be optional feature. The spring 1034 can allow for the linear gear 1032a (left rack) to be positioned downward allowing the linear gear 1032a to engage properly with the handle (not shown). In some examples, provided the cartridges 1004, 1020 are removed from their corresponding handles, the spring 1032 allows for automatically re-positioning and/or re-positioning of the linear gears 1032a, 1032b, and circular gear 103. In some examples, without the spring 1034 the linear gears 1032a, 1032b, and circular gear 103 can be misaligned upon removal of the handle. In one example, the spring 1034 allows for the linear gear 1032a to maintain the bottom position.

FIG. 10-13 illustrates an exemplary handle, according to some embodiments. In some embodiments, the handle 1002 is the same handle used with the teeth cleaning apparatus 1000 described for FIGS. 10-1 to 10-12. In some examples, the handle 1002 includes an electric motor 1040 that can be used to drive the brush-heads 1006 of the teeth cleaning apparatus 1000 described in FIGS. 10-1 to 10-12. The handle 1002 can include gear box 1040, spur gear 1044, a comb gear 1046, a crank 1048, and a sliding mechanism 150. The handle can include a power supply 1052. The power supply 1052 can provide power for components within the handle 1000 and/or the teeth cleaning apparatus 1000, such as lighting elements, controlling elements, sensing elements, etc. The power supply 1052 can include a battery 501. The power supply 1052 can be located at a lower part of the handle 1002, as shown. The power supply 1052 can provide DC power to the components of the teeth cleaning apparatus 1000. In some examples, the power supply 1052 can be used to power the gear box 1040 and/or motor 1040. The power supply 1052 can drive the motor 1040 to move the crank 1048/crankshaft. The handle 1002 can use a scotch yoke and/or other mechanism to convert rotary motion to reciprocating linear motion, as shown. In some examples, the handle 1002 can provide linear actuation that is translated to a metal shaft 1054. The metal shaft 1054 can come out of a top of the handle through a bayonet feature 1056.

FIG. 10-14 illustrates a bayonet feature, according to some embodiments. In some embodiments, the bayonet feature 1056 can be the same bayonet feature 1056 from FIG. 10-13. In some examples, the bayonet feature 1056 allows the cartridges 1004, 1020 to twist and/or lock to the handle 1002, where it is driven by the shaft 1054 of the handle 1002.

FIG. 10-15 illustrates a handle engaged with a cartridge, according to some embodiments. In one example, a bottom side of the cartridges 1004, 1020 that is engaged with the handle 1002 is shown. In some examples, the cartridges 1004, 1020 can convert rotary shaft output of the handle 1002 to dual reciprocating motion using a gearbox 1058. The gearbox 1058 allows for converting the rotary shaft output of the handle to a dual reciprocating motion from within the cartridges 1004, 1020. The gearbox 1058 can have a same or similar configuration as the gearbox 1040 of the handle 1002. In one example, the gearbox 1058 can include a crank shaft and/or scotch yoke mechanism, among others. In some embodiments, the configuration shown in FIG. 10-15 provides an advantage of reducing the number of parts that can be worn down (e.g., as consumables). The gearbox 1058 can be used alternatively to other configurations such as in contrast to using an exposed reciprocating shaft. The configuration shown in FIG. 10-15 is one configuration that can be used to connect cartridges 1004, 1020 with a handle 1002. The teeth cleaning apparatus 1000 described in FIGS. 10-1 to 10-15 is not limited to this configuration (e.g., shown in FIG. 10-15), where configurations can be used.

FIG. 10-16 illustrates a brushing cartridge having a movable central brush, according to some embodiments. In some embodiments, the brushing cartridge 1060 can include a movable central brush 1062 attached to one of the brush-heads 1006a, 1006b. As described herein the movable central brush 1062 can be referred to herein as a central brush 1062. As shown in FIG. 10-16, the central brush 1062 can be connected to the brush-head 1006a. In one example, the central brush 1062 can be connected to brush-head 1006b. In some embodiments, the central brush 10062 can be used to clean a biting surface, e.g., a top or bottom surface, of the user's tooth. In some examples, the central brush 1062 can be connected to either the brush-head 1006a or 1006b, as opposed to connected to both brush-heads 1006a, 1006b. The central brush 1062 can move with the brush-heads 1006a and/or 1006b, e.g., whichever brush-head the central brush 1062 is connected to. In some examples, the central brush 1062 can be referred to as a movable central brush 1062. In some examples, the central brush 1062 can be added and/or used together with the configurations shown for the brushing cartridges 1004, 1020.

FIGS. 10-17, 10-18 and 10-19 illustrate a cartridge having a central guide, according to some embodiments. In some embodiments, the central guide 1066 of the cartridge 1064 can be stationary. In some examples, the central guide 1066 can include a brush and/or bristles. In one example, the central guide 1066 can be include a stationary central brush. The central guide 1066 can be connected to a support structure 1022 (e.g., similar to and/or the same as the support structure 1022 of FIGS. 10-8 to 10-10). The description for the support structure 1022 of FIGS. 10-8 to 10-10 can apply to the support structure 1022 described in FIGS. 10-17 to 10-19. In some examples, the central guide 1066 can be added and/or used together with the configurations shown for the brushing cartridges 1004, 1020. In some examples, the central guide 1066 does not include a brush. In some embodiments, the central guide 1066 can be used as a guide during operation of the teeth cleaning apparatus 1000. In some examples, the central guide can be used to lightly contact a top and/or underside of the user's teeth and provide feedback to the user to guide the user during operation of the teeth cleaning apparatus 1000. The central guide 1066 can automatically and/or allow the user to more easily gauge a position of the brush-heads 1006a, 1006b in contact with the user's teeth during cleaning. The central guide 1066 can be used to determine how far down the user's mouth the brush-heads 1006a, 1006b should be engaged. In some examples, the central guide 1066 can provide tactile feedback to the user by contacting a top and/or bottom of one or more of the user's teeth.

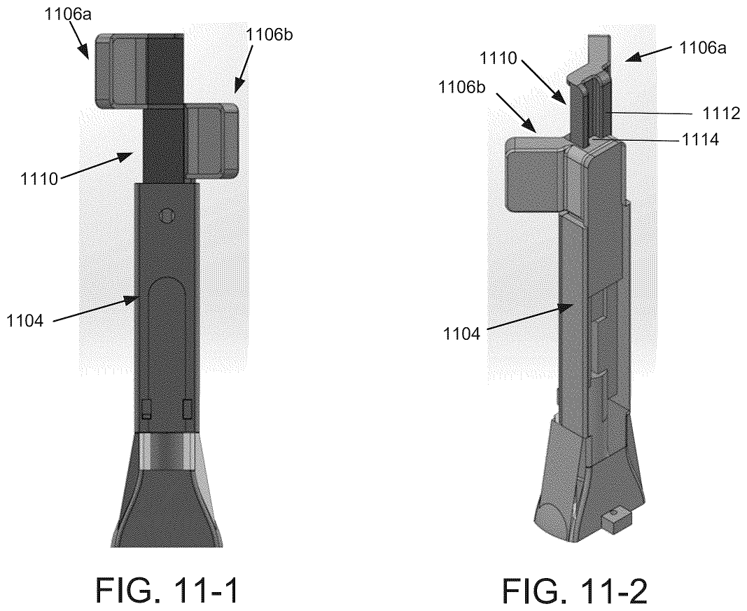

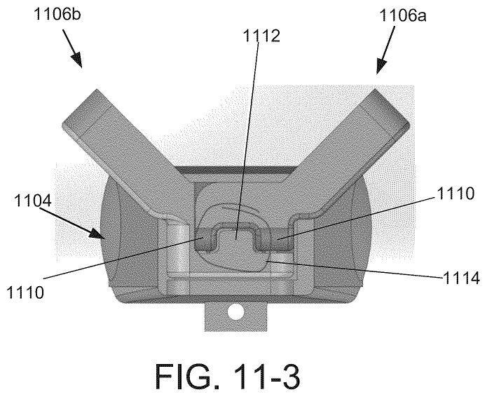

FIGS. 11-1, 11-2 and 11-3 illustrate a brushing cartridge for a teeth cleaning apparatus, according to some embodiments. FIGS. 11-1, 11-2, and 11-3 can be collectively referred to as FIG. 11. The brushing cartridge 1104 can include brush-heads 1106a and 1106b (e.g., shown without bristles attached) attached to a rail 1110. The rail 1110 can include two racks 1112, 1114 corresponding for each brush-head 1106a, 1106b respectively. In some examples, the rails 1112, 1114 can be nested within one another as shown in FIGS. 11-2 and 11-3. The tracks 1112, 1114 can be nested into each other on one side, providing rigidity and/or support as each track 1112, 1114 glides back and forth. The rail 1110 can include a channel (shown encircled in FIG. 11-3) that can be adjusted to allow room for flexing and/or extension of the tracks 1112, 1114, while still keeping a movement of the rail 1110 controlled and smooth. The brushing cartridge 1104 can be used with the teeth cleaning apparatus and/or the brushing cartridges described herein. In some examples, the bushing cartridge 1104 can be used with the teeth cleaning apparatus 1000, brushing cartridges 1004, 1020 of FIG. 10. The features described in FIG. 11 can be used together with, and/or in combination with, the embodiments described in FIG. 10.

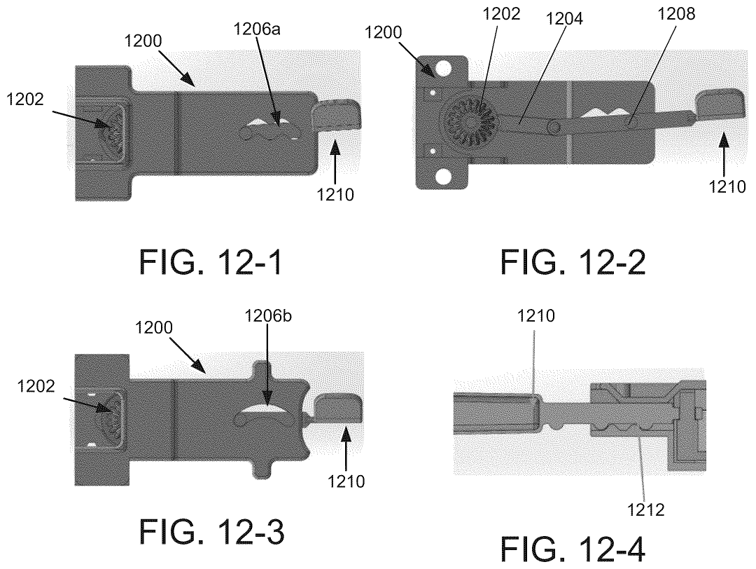

FIGS. 12-1, 12-2, 12-3 and 12-4 illustrate an exemplary configuration using linear motion for driving an armature to add in another degree of motion for a brush-head, according to some embodiments. In some embodiments, the brushing cartridges 1200a, 1200b can include a gear 1202, an armature and/or camshaft 1204, slots 1206a, 1206b, a slot pin 1208 inserted within the slots 1206a, 1206b, and/or a spring beam mechanism 1212. The camshaft 1204 can be connected to a brush-head 1210. The brush-head 1210 can include brush receptacle (e.g., bristles are not shown). In some examples, moving the gears 1202 can move the camshafts 1204 in a motion defined by the slots 1206a, 1206b. FIG. 12-1 shows a front side of a brushing cartridge 1200a including the slot 1206a having a wavey and/or sawtooth configuration 1206a, and FIG. 12-2 includes a back side view of the same cartridge 1200a from FIG. 12-1. FIG. 12-3 shows a brushing cartridge 1200b having a slot 1206b in a shape of an arc. The slots 1206a, 1206b can be in a shape for producing reciprocating motion. In some examples, the reciprocating motion can include moving brush-heads 1210 in an additional axis of motion. For example, moving the crankshaft 1204 using the gear 1202 can move the brush-heads 1210 up-and-down. Moving the crankshaft 1204 using the gear 1202 can move the brush-heads 1210 in a sawtooth pattern, in a wave pattern, in an arc motion, among others. The reciprocating motion can include a vibrational motion controlled by the slots 1206a, 1206b, gear 1202 and camshaft 1204. In some embodiments, the motion controlled and/or generated (e.g., using the same or similar configurations shown in FIG. 12-1 to 12-4) can include a right and/or left brush-head producing equal and opposite motion at a same time (e.g., to counter balance each other). In some examples, the motion of the brush-heads 1210 used can produce equal and opposite linear motion. In one example, including a second axis of motion to the brushing cartridges 1200a, 1200b can counter balance the movement of brush-heads going in opposite directions. (i.e. one brush-head can go up, while another brush-head can go down).

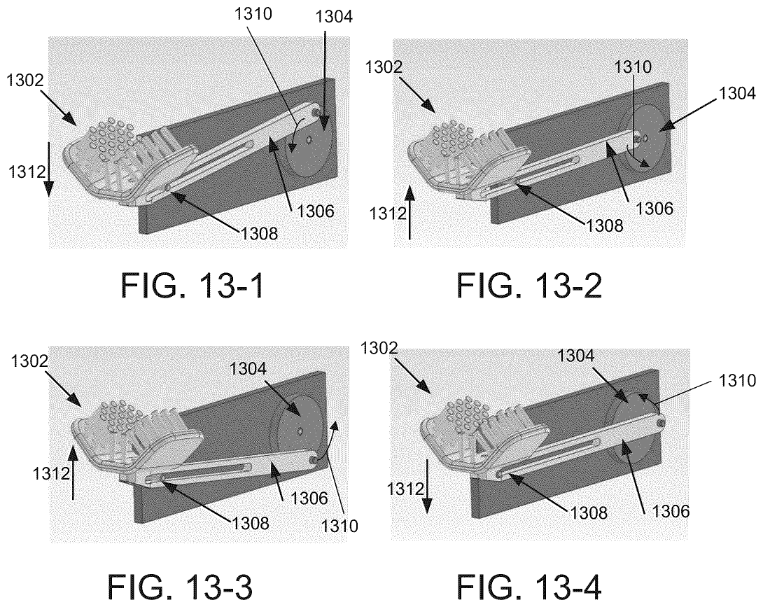

FIGS. 13-1, 13-2, 13-3 and 13-4 illustrate a slot pin configuration for a brush-head, according to some embodiments. FIGS. 13-1, 13-2, 13-3 and 13-4 can be collectively referred to as FIG. 13. In some embodiments, FIG. 13 shows a brush-head 1302 connected to a to a wheel 1304 via a linkage 1306. The linkage 1306 can have a pivot 1308. In some examples, a rotational motion 1310 of the wheel 1304 can be converted to a brushing motion 1312 of the brush-head 1302 via the movement of the linkage 1306 along a pivot 1308 enacted on by the wheel 1306. In some examples, FIG. 13 shows a motion 1312 for the brush-head that is converted from rotational motion 1310 when the wheel 1304 is rotated. The motion 1310, 1312 can start at FIG. 13-1, shown next in FIGS. 13-2, 13-3, 13-4 and back to FIG. 13-4. FIG. 13 shows an example where the brush-head 1302 moves up-and-down in a motion 1312 generated by the linkage 1306 connected to the pivot 1308. FIG. 13 can include a similar configuration to FIGS. 6N and 6O with the addition of the linkage 1306 on a pivot 1308, as shown. The configuration shown in FIG. 13 can be used to provide a counterbalanced reciprocating motion of the brush-head 1302 as shown. Although one brush-head 1302 is shown, more than one (e.g., two brush-heads) can be controlled and/or use in the configuration shown. The configuration shown in FIG. 13 can be used with, and/or in combination with, the brushing cartridges described herein.

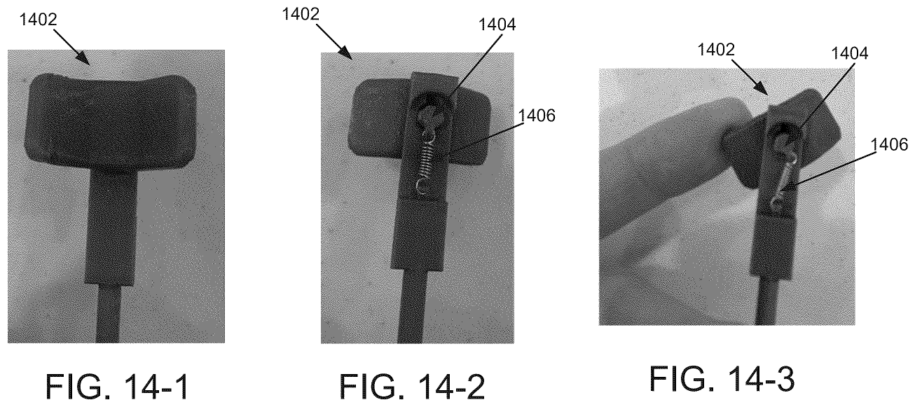

FIGS. 14-1, 14-2 and 14-3 illustrate a brush-head having a pivot, according to some embodiments. FIGS. 14-1, 14-2 and 14-3 can be collectively referred to as FIG. 14. In some embodiments, a brush-head 1402 is shown having a pivot 1404. The pivot can be connected to a spring 1406. In some examples, the brush-head 1402 can be counterbalanced via the movement of the pivot 1404 connected to the spring 1406. The counterbalance can be used to stabilize the brush-head 1402 when contacting one or more teeth of the user during cleaning. The spring 1406 allows the brush-head 1402 to pivot with resistance, e.g., using internal flexible plastic features 1404. The brush-head 1402 can be used with, and/or in combination with, the brush-head described herein.

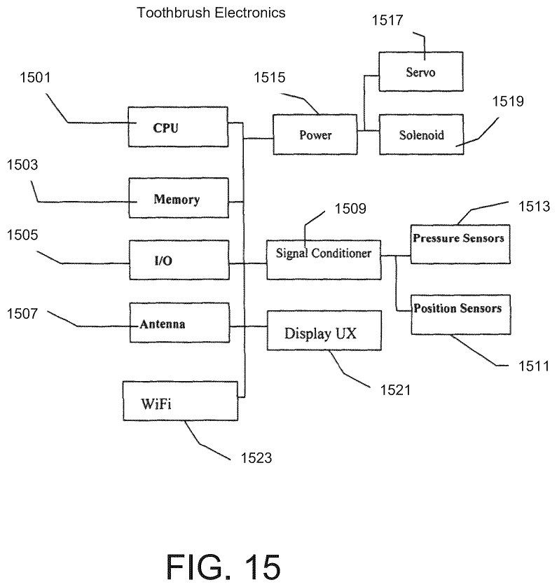

FIG. 15 illustrates a block diagram showing control system hardware components of a powered toothbrush, according to some embodiments. A control system can be implemented in many configurations and programming environments. As illustrated in FIG. 15, the toothbrush device can include a processor CPU 1501, associated memory 1503, a I/O processor 1505, antenna 1507, network adaptor 1523, power supply 1515, servo motor 1515, solenoid 1519, and associated circuitry and numerous other elements and functionalities typical of today's consumer device electronic smart devices. The wireless device 1523 can also include input means, such as a wireless keyboard, not shown, or a light pencil, not shown, and output means, such as display 1521 local and remote. The wireless device 1523 can be network connectable to a local area network (LAN) or a wide area network (e.g., the Internet) (not shown) via a network interface. Those skilled in the art will appreciate that these input and output means can take other forms.

The I/O processor 1505 can service and interface with many devices and sensors including but not limited to pressure 1513 and positions sensors 1511, transducers, touch screen 1521, motion sensors, light sensors, proximity sensors, power switches, wireless communication 1523, audio subsystem, camera, video, signal conditioner 1509, ultrasonic sensor, and others. These devices and sensors are all sources of primary information for hygienic brushing activities to be used in embodiments of the smart toothbrush.

In an embodiment, a drive mechanism in the form of roller chain is driven by a servo motor 1517 under logic and programming 1501 1503 1505. In an embodiment a drive mechanism can be a servo motor 1517 powering a gear train using a variable resistance potentiometer for providing feedback for positioning information on the angle of the drive shaft. Pressure sensor 1513 feedback provides for control instructions for positioning to servo 1517 moving brush to angle x degrees, while also moving the belt via servo to the precise position, adjusting for friction, drag and other forces. This feedback positioning also allows the control system to programmatically control the location and timing of the brushes with preset accuracy and oscillation frequency.

In some embodiments, the computer can know where the brush-head (s) is (e.g., through the encoder on the motor or by other means). Because of that, a control or App can control brushing and set by either the user or dentist. For example, a user can set extra brushing on certain teeth, light brushing, or even skip a tooth if they wanted. The product can then spend extra or less time on a particular region and brush faster/slower etc.

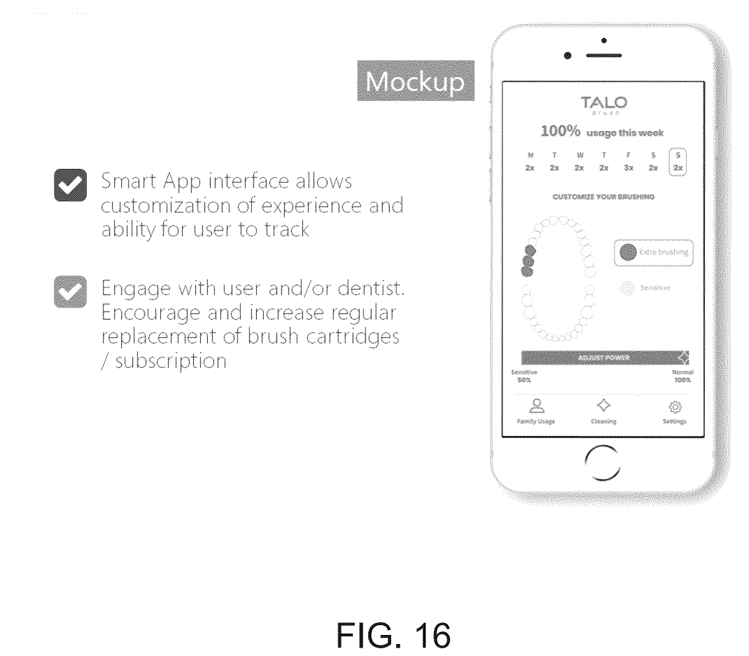

FIG. 16 illustrates an example user interface for an App running on a mobile device, according to some embodiments. The application can control the operation of the powered brush and can set up a communication with the brush through a wired or wireless communication. For example, the interface can allow a user to configure the brushing parameters, such as length for each tooth in general, length for a specific tooth in special, etc., thereby allowing customization of experience. The application can also allow a user to track brushing activities to make sure that a good brushing habit is established.

In some embodiments, a feature like this can be implemented into even a “traditional” electric toothbrush, such as Sonicare, Oral B, whereby onboard sensors can have a map of the teeth and as the brush-head is moved by the user over a particular area/teeth, the toothbrush can adjust higher power/lower power etc. based on pre-programming. The App can also tell the user to spend more time on a particular tooth/teeth through haptics, sound or LCD screen if needed, such as if the user programmed in extra brushing on a particular tooth/teeth to not move on before they get haptic feedback, etc.

As described above, the disclosed powered brush uses one or more brushes that are driven by a belt/system/motor. In some embodiments, the position of a brush-head can be recognized and self-corrected/adjusted by the encoder attached to the end of the motor. Therefore, this mobile device disclosed herein is in a unique position to be able to embody a system (through an App or other means) that allows a user to select a tooth/teeth if desired, that the user would like extra brush on/or lighter/less brushing on. The App and PCB on board can take this data and adjust how many octillions/speed/length of oscillations over the area where a particular tooth is. The user can also adjust the overall speed/intensity etc. Through the App or other module, the mobile device can track brushing as metrics and can connect to multiple devices (such as for a family) so the user can view/track kids brushing. Since as long as the powered brush is being used, it is brushing all the teeth, a user only needs to know the brush is being used. In some embodiments, data collected from the brush/device can be transmitted to the App.

In some embodiments, the PCB disclosed herein can detect current. Accordingly, when a brush-head reaches the end of the mouth, it won't be able to move forward anymore since there is no room to move. The PCB can detect high current draw or stall and recognize that position as the end of the mouth for instance, learning the size of the person's mouth for future use. It can also use some combination of user input and learning to adjust the software programming/speed, length to travel, number of oscillations, size of oscillations, etc. Current draw can also be used to detect if the brush-head is stalled and stop the motor after a certain amount of seconds of attempting to move. This can prevent motor stall/overheating/reduced lifespan. Also it can be used to alert the user there is a blockage through a haptics vibration or light on the handle and the like, or recognize if the user is biting too hard down and alert them. It can also tell the motor to “back up” if it runs into a block/resistance.

Another way the device can learn is that the user initially can go through a setup module that will advance the brush-head tooth-by-tooth and has the user enter feedback to select which tooth/teeth the brush-head is actually on. Similar to printer/alignment or scanning setup on a printer/scanner device, the device can take the real world feedback to learn/adjust its own settings and create a map of the user's teeth.

In some embodiments, data can be sent to a dentist/treatment provider or the provider can input setting information (e.g., extra brushing on certain teeth, etc.) for the user. Info can be transmitted via various wireless/wired means.

In some embodiments, the device disclosed herein can have a unique ability for a toothbrush to know its own space/time (where the brush-head ss are in the mouth at any given time). It is possible to incorporate sensors on the cartridge or brush-head that can therefore gather information, which can be transmitted back to a module to create a 3D pictorial/info on metrics. Data that might be further collected include PH in the mouth, saliva, and so on. Camera/light sensors can detect color of teeth, gums, receding gums/inflammation, temperature, stains, lack of saliva (dryness), indications of plaque, debris, debris between teeth, etc., all of which can provide guidance for good teeth health. For example, the collected information can indicate certain areas that require waterpic or flossing, certain areas can need to brush more/less, and enamel can be wearing down.

In some embodiments, in the toothbrushes disclosed herein where the user moves the brush from tooth-to-tooth, this data can still be collected. Bacteria/microbe samples could theoretically also be taken. Some of these metrics like PH, color, moistness could be used to determine correlation to other health/medication/infection issues. In an alternative embodiment, the brush-head that moves around the mouth can also just be a data collection device, even without the brushes, or can be just a scanning/collection device for scanning a user's mouth, by the user/dentists/etc. In view of this, the disclosed device can allow people to stick in their mouth twice a day and collect a barrage of data on a regular basis, which can be used for adjustment for space/time and so on.

According to some embodiments, it can be necessary to reset the device or backup brush-head on the teeth manually, in which case holding in the power button on the handle can be used to slowly “rewind” brush-head (i.e., move it back).

In some embodiments, when a user brushes the teeth manually, the user's arms are moving the brush back and forth and from tooth to tooth. These back and forth motions naturally have different lengths and distance, and thus there are slight natural variations between users. In the disclosed powered brushes, since the brushing is pre-programmed into a brush, the stroking motions are programmed in equal lengths/distances to move the brush back and forth. This is true with most other existing electric toothbrushes too. It is found that generating back and forth strokes with different lengths instead created more efficacy with plaque removal (randomness). It can be due to the reason that it allows the brush to agitate the plaque from different angles better and more accurately replicates the way the people brush/clean, which is not in perfect equal length strokes. Another possible reason for the benefit is some of the bristles, in the course of brushing, bend and flex at different angles as the brush moves back and forth. Generating random or alternating lengths of that stroking motion allows the bristles to flex and move to different degrees and brushes from more angles. This methodology can also be applied to other existing regular electric toothbrushes, and these brushes can clean better using random or alternating/changing motions and/or power, such as spin brushes, Sonicare type brushes etc. In some embodiments, these random or alternating/changing motions can also be incorporated to the brush as well.

In one mode of “sweeping motion” operation, the brush brushes back and forth on a tooth/set of teeth and advances to the next set of teeth, until the brush reaches the end of all the teeth. An alternative mode includes that the brush travels from the start position all the way to the end of the track and back again, repeating this an equivalent amount of times to brush the teeth this way. Instead of short stroking motions, the brush performs long stroking motions.

In some embodiments, for smoother use and to address “kick-back” during operation, the motor disclosed herein can choose a slower stop/start instead of abrupt stopping/starting. This can be done through programming. The motor/encoder can be programmed to stop when it reaches the desired position and pause before reversing and restarting the motor.

In some embodiments, rapid back and forth movements of the brush, the abrupt stopping of movement and reversal of movement can translate into “jerking” or kick-back motion of the mouthpiece inside a user's mouth during use. This is particularly true if the mouthpiece has brushes on both sides (upper and lower) since more ‘drag’ is created. One method of dealing with this is to have a part of the mouthpiece or an internal component in the handle, such as the chassis within the handle, which is configured to absorb some of kick-back motion. The chassis, for example, can be made in a way that allows it to slide up or down slightly (possibly spring-loaded like a shock absorber) or twist (absorbing torsion), while staying engaged with the gears. In this way, some of the kick-back motion can be absorbed, and not translated into kick-back inside the user's mouth.

In some embodiments, a belt described above can be a tube (for carrying fluid). In some examples, the drive belt system can include tubular in shape, be hollow, and/or include a flexible tube. This can allow it to be more flexible, but the primary purpose is that a user can then use that tube to carry a liquid (water, toothpaste, mouth washing, etc.) to the brush-head directly to which it is attached. In this way, a user can use the driving belt/features to also carry fluid/air, etc., allowing it to serve two purposes at the same time, since there is limited room. That is, the belt system is also used as a delivery system.

In some embodiments, the system disclosed herein can deliver micro/small gentle bursts of air as it is brushing/flossing, to add to the cleaning, help dislodge food/plaque/massage teeth/gums. It can do this in streams or small bursts for possible different effects.

In some embodiments, two motors can be used on separate belts to independently control the two brush-heads.

In some embodiments, the belt and drive system can be not used, instead a chain and sprocket style drive system are used.

In some embodiments, the handle can include sound and vibration damping materials both on the inside walls, and on the motor mounting.

In some embodiments, an exit hole or a suction can be included in the disclosed system, so it doesn't just spill water out of a user's mouth. Instead, water sent into the mouth is also sucked out or has an exit hole that drains in a neater fashion. According to some embodiments, the returned water can also be processed through a filter and reused in the same session, such that with a relatively small amount of water, it can be enough to provide a full flossing session/waterpic session over the entire mouth. This can be useful for keeping handle more portable and smaller for traveling since in this instance a user can be able to get away with a small water reservoir.

In some embodiments, a brush-head can pivot. In the disclosed embodiment, brush-head is used as a generic term, generally meaning the part that contains bristles that is controlled and moved around a user's teeth. In some embodiments, a brush-head needs not have bristles, and it merely represents a component that is moved around the mouth, for example, it can just be for a water-pic, or to take photos of teeth, etc.

In various embodiments described above, while the primary goal is oral care, some of the technology could be used to make other devices/robotics, including but not limited to smart tools, personal care devices, massagers, sexual toys. In those other forms, the device can take on different embodiments.

### Terminology

The phraseology and terminology used herein are for the purpose of description and should not be regarded as limiting.

The term “approximately”, the phrase “approximately equal to”, and other similar phrases, as used in the above descriptions (e.g., “X has a value of approximately Y” or “X is approximately equal to Y”), should be understood to mean that one value (X) is within a predetermined range of another value (Y). The predetermined range may be plus or minus 20%, 10%, 4%, 3%, 1%, 0.1%, or less than 0.1%, unless otherwise indicated.

The indefinite articles “a” and “an,” as used in the above descriptions, unless clearly indicated to the contrary, should be understood to mean “at least one.” The phrase “and/or,” as used in the above descriptions, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” may refer, in one embodiment, to A only (optionally including elements other than B); in another embodiment, to B only (optionally including elements other than A); in yet another embodiment, to both A and B (optionally including other elements); etc.

As used in the above descriptions, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, “consisting of,” will refer to the inclusion of exactly one element of a number or list of elements. In general, the term “or” as used shall only be interpreted as indicating exclusive alternatives (i.e. “one or the other but not both”) when preceded by terms of exclusivity, such as “either,” “one of,” “only one of,” or “exactly one of” “Consisting essentially of” shall have its ordinary meaning as used in the field of patent law.

As used in the above descriptions, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) may refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The use of “including,” “comprising,” “having,” “containing,” “involving,” and variations thereof, is meant to encompass the items listed thereafter and additional items.

Use of ordinal terms such as “first,” “second,” “third,” etc., to modify an element does not by itself connote any priority, precedence, or order of one element over another or the temporal order in which acts of a method are performed. Ordinal terms are used merely as labels to distinguish one element having a certain name from another element having a same name (but for use of the ordinal term), to distinguish the elements.

What is claimed is:

1. A teeth cleaning apparatus, the apparatus comprising:
an arched mouthpiece that conforms to a user's dental arch;
a first brush-head including a bristle substrate having two or more planes and being disposed within the arched mouthpiece, the first brush-head located on an upper side of the arched mouthpiece, wherein the first brush-head cleans individual teeth of the user while moving from a first position to a second position along the arched mouthpiece; and
a transmission track having a first cavity that receives the first brush-head, the transmission track located within the arched mouthpiece, wherein the transmission track facilitates a back-and-forth motion of the first brush-head.

2. The teeth cleaning apparatus of claim 1, further comprising:
a second brush-head including a bristle substrate having two or more planes and being disposed within the arched mouthpiece, wherein the second brush-head cleans individual teeth of the user while moving from the first position to the second position along the arched mouthpiece; and
wherein the transmission track facilitates a back-and-forth motion of the second brush-head.

3. The teeth cleaning apparatus of claim 1, further comprising:
a second brush-head including a bristle substrate having two or more planes and being disposed within the arched mouthpiece, wherein the second brush-head cleans individual teeth of the user while moving from the second position to the first position along the arched mouthpiece; and
wherein the transmission track facilitates a back-and-forth motion of the second brush-head.

4. The teeth cleaning apparatus of claim 3, wherein the first and second brush-heads are connected together by a belt.

5. The teeth cleaning apparatus of claim 3, wherein the second brush-head is positioned directly underneath the first brush-head.

6. The teeth cleaning apparatus of claim 1, wherein the arched mouthpiece is J-shaped.

7. The teeth cleaning apparatus of claim 1, wherein first brush-head moves in an up-and-down motion.

8. The teeth cleaning apparatus of claim 1, wherein the transmission track includes a second cavity that receives a second brush-head.

9. The teeth cleaning apparatus of claim 1, further comprising a power source disposed within a housing of the teeth cleaning apparatus.

10. The teeth cleaning apparatus of claim 1, wherein the first position is located in an inner side of the user's mouth, and the second position is located in an outer side of the user's mouth.

11. A teeth cleaning apparatus, the apparatus comprising:
a brushing cartridge that conforms to a user's dental arch;
a first brush-head having a bristle substrate and being connected by a respective beam to the brushing cartridge, wherein the first brush-head cleans individual teeth of the user while moving from a first position to a second position with respect to the brushing cartridge;
a second brush-head having a bristle substrate and being connected by a respective beam to the brushing cartridge, the second brush-head located adjacent to the first brush-head, wherein the second brush-head cleans individual teeth of the user while moving from the second position to the first position with respect to the brushing cartridge; and
wherein the brushing cartridge facilitates a back-and-forth motion of the first and second brush-heads.

12. The teeth cleaning apparatus of claim 11, wherein the first brush-head is located on an upper side of the brushing cartridge.

13. The teeth cleaning apparatus of claim 12, wherein the second brush-head is located on the upper side of the brushing cartridge.

14. The teeth cleaning apparatus of claim 11, wherein the brushing cartridge comprises a support structure that receives the first brush-head and the second brush-head.

15. The teeth cleaning apparatus of claim 11, wherein the first position is located away from the brushing cartridge, and the second position is located adjacent to the brushing cartridge.

16. The teeth cleaning apparatus of claim 11, wherein the first brush-head and second brush-head are connected together by a gear.

17. The teeth cleaning apparatus of claim 11, wherein first and second brush-heads move in an up-and-down motion.

18. The teeth cleaning apparatus of claim 11, further comprising an arched mouthpiece connected to the brushing cartridge.

19. The teeth cleaning apparatus of claim 18, wherein the arched mouthpiece comprises a transmission track that includes two cavities that receive the first brush-head and the second brush-head, respectively.

20. The teeth cleaning apparatus of claim 11, further comprising a power source disposed within a housing of the teeth cleaning apparatus.
